(19) United States
(12) Patent Application Publication
(10) Pub. No.: US 2026/0064773 A1
(43) Pub. Date: Mar. 5, 2026

(54) INTERFACE TO ORGANIZE AND ADMINISTER GRAPH-ORIENTED FILE SYSTEM

(71) Applicant: Oracle International Corporation, Redwood Shores, CA (US)

(72) Inventors: Gustavo Rueda, Zapopan (MX); Lourdes Gabriela Guzman Fernandez, Zapopan (MX); Mauricio Perez Hernandez, Zapopan (MX)

(21) Appl. No.: 18/822,871

(22) Filed: Sep. 3, 2024

(51) Int. Cl. G06F 16/901; G06F 16/16

(52) U.S. Cl. CPC G06F 16/9024; G06F 16/168

(57) ABSTRACT

Disclosed herein are various approaches for visualizing a graph-organized file system (GOFS) using a graphical user interface. A GOFS may represent a graph comprising a plurality of nodes and one or more edges representing one or more relationships between the plurality of nodes. A user interface comprising a representation of at least a portion of the graph may be rendered in a display accessible to one or more computing devices. A file system command for the GOFS may be received via the user interface, and the user interface may be modified based at least in part on executing the file system command.

### RELATED APPLICATION DATA

This application is related to U.S. patent application Ser. No. 17/719,555, filed Apr. 13, 2022, the contents all of which are incorporated by reference in their entirety for all purposes as if fully set forth herein.

### TECHNICAL FIELD

The present disclosure relates to a user interface for a graph-organized file system.

### BACKGROUND

A file system defines (a) a data structure that an operating system of a computing device uses to store user data and (b) a user interface to access and manipulate the stored data. A file system generally organizes stored data into components, such as files and directories, which are arranged in a hierarchical data structure. A hierarchical data structure is defined by a root directory that acts as a mount point for the file system, where each directory in the hierarchy may store one or both of lower-level directories and/or files of any type, such as text, image, video, audio, etc. Generally, files and directories are associated with metadata (such as name, owner, last-edited timestamp, etc.), and may be relocated within the defined hierarchical data structure under the root directory.

Graphical user interfaces (GUIs) to access and manipulate data in a file system can make the file system more readily and efficiently usable. A graphical user interface (GUI) for file systems can have several different aspects. For example, a file system GUI can enable user-friendly navigation. A GUI provides a visually intuitive way for users to navigate through the file system. Users can explore folders, view file details, and understand the hierarchical structure of the file system more easily than using a command-line interface. As another example, a file system GUI enables file operations. The file system GUI can simplify common file operations such as renaming, copying, moving, and deleting files. Users can perform these actions using a point-and-click method, making it more accessible for those who may not be familiar with command-line syntax. As a further example, a file system GUI can enable search functionality. A file system GUI can include a search feature, allowing a user to quickly locate files based on keywords or other criteria. A graphical search feature can be more convenient than using complex search commands in a terminal.

In situations where a traditional file system cannot adequately represent complex data and complex data relationships, however, a graph-organized file system (GOFS) can be useful. A GOFS can represent connections between files that are more complicated than those represented by a traditional, hierarchical file system. A GOFS represents a data graph with graph components comprising a plurality of nodes and one or more relationships between the nodes. Each node of the graph may be associated with content (of any kind) and/or relationships (of any kind) between the node and other nodes in the graph.

Yet the complexities of a GOFS make it impracticable to access and manipulate data in the GOFS using a traditional file system GUI at all, let alone in a user-friendly manner. For example, because a traditional file system GUI is configured to represent the hierarchical relationships between files in a hierarchical file system, it is not equipped to represent the relationships between files that are captured by edges in a GOFS. As another example, the file operations enabled by a traditional file system UI as a file deletion cannot be performed in a similar manner on files in a GOFS because of the structural and relational complexities of the graph structure of the GOFS. Thus, it would be desirable to develop a graphical user interface that enables a user to exploit all of the capabilities of a GOFS in a user-friendly manner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates an example of a computing system running an application having a GOFS user interface in a user space of the computing system, according to various embodiments of the present disclosure.

FIG. 1B depicts an example GOFS partition, according to various embodiments of the present disclosure.

FIGS. 2A-B illustrate examples of origin and workspace views of the GOFS UI, according to various embodiments of the present disclosure.

FIGS. 3A-D illustrate examples of interfaces of the GOFS UI for performing operations on nodes and edges in the GOFS, according to various embodiments of the present disclosure.

FIGS. 4A-H illustrate examples of interfaces for performing a delete operation on a node in the GOFS UI, according to various embodiments of the present disclosure.

FIGS. 5A-F illustrate examples of interfaces for performing a delete operation on an edge in the GOFS UI, according to various embodiments of the present disclosure.

FIGS. 6A-E illustrate examples of interfaces for configuring node visualization depth in the GOFS UI, according to various embodiments of the present disclosure.

FIGS. 7A-G illustrate examples of interfaces for performing queries in the GOFS UI

FIG. 8 is a flow diagram that illustrates an example process for automatically deleting a node in the GOFS UI, according to various embodiments of the present disclosure.

FIG. 9 is a block diagram that illustrates a computer system upon which an embodiment of the invention may be implemented, according to various embodiments of the present disclosure.

FIG. 10 is a block diagram of a basic software system that may be employed for controlling the operation of a computing system, according to various embodiments of the present disclosure.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1. GENERAL OVERVIEW

Disclosed herein are various approaches for visualizing a GOFS using a graphical user interface. The disclosed GOFS UI may clearly depict files of the GOFS and the relationships between them as nodes and edges in a graph, respectively. The GOFS UI may enable users to perform various operations on the nodes and edges and query the graph. The GOFS UI may thus enable users to perform complex actions with respect to the GOFS in an easy and user-friendly way.

The GOFS UI may implement user-friendly navigation and file operations in a GOFS. For example, the GOFS UI may implement an origin view that enables a user to view various user-defined workspaces of the GOFS. A workspace may be defined through a “spotlight node”, which is a node that serves as a point of reference from which other nodes in the GOFS may be depicted in that workspace. As another example, the GOFS UI may implement a workspace view that enables a user to view the nodes in a particular workspace, as well as the edges that connect them. The workspace view may be capable of showing every node that is accessible to the corresponding spotlight node, though the workspace view may present some or all of these nodes in a personalized, organized, and coherent manner. The workspace view may present a user with one or more visualization options that change how nodes and edges in the workspace are depicted. Using the workspace view, the user may perform various operations on these nodes and edges, such as create, read, update, and delete (CRUD) operations.

The GOFS UI may implement a complete search functionality for querying the graph of the GOFS. The GOFS UI may enable a user to perform graph queries using tags on the nodes of the graph. A user may provide a query expression, and the GOFS UI will show nodes matching the regular expression with their corresponding edges.

The GOFS UI may enable deletion of nodes and readjust the graph after node deletion. The GOFS UI may support both manual and automatic graph readjustment. During manual graph readjustment, the user may be presented with a specialized view that enables the user to reconnect/adjust edges among the remaining nodes to prevent node deletion from leaving any “orphan” nodes unconnected to the rest of the graph. During automatic node deletion, the GOFS UI may reconnect edges between nodes related to the node that will be deleted, allowing the node to be safely removed from the graph. Automatic node deletion prevents orphan nodes without requiring the user to know how to properly adjust the graph manually.

### 2. OPERATING SYSTEM IMPLEMENTATION OF GRAPH-ORGANIZED FILE SYSTEM

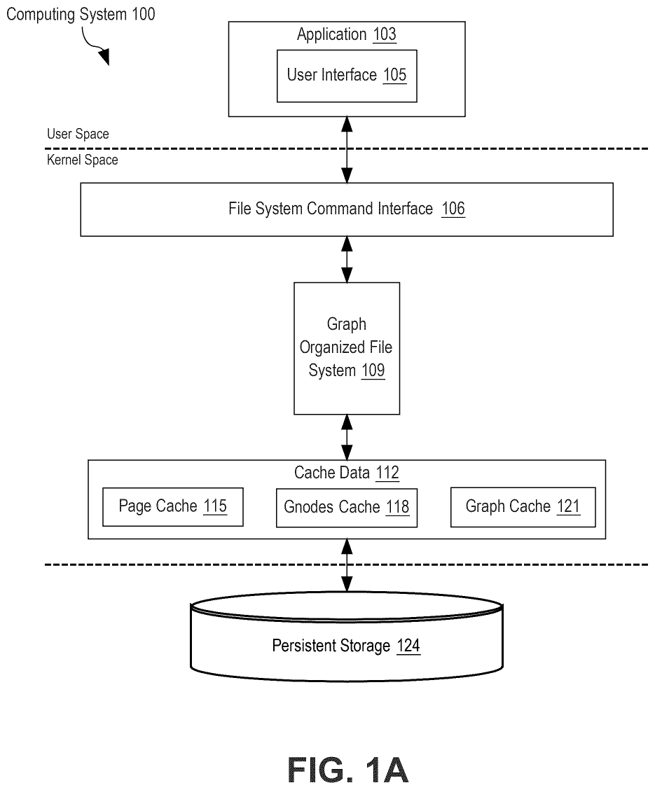

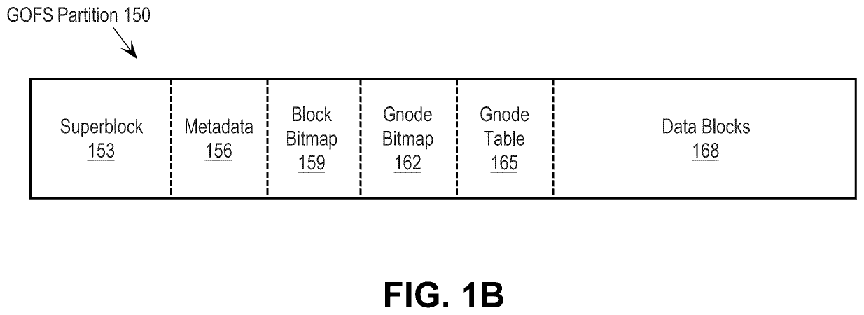

FIG. 1A illustrates an example of a computing system 100 running an application 103 having a GOFS user interface 105 in a user space of the computing system 100. The computing system 100 implements a file system command interface 106 that routes GOFS file system commands to a GOFS of one or more GOFS implemented by the computing system 100, such as GOFS 109. GOFS 109 is example kernel software that implements a particular GOFS according to techniques described herein.

To improve the latency of GOFS-based I/O read and write operations to persistent storage 124, GOFS 109 may maintain and/or use cache data 112 including one or more caches, such as a page cache 115, a gnodes cache 118 (where the gnodes cache is similar in function and/or form to an inodes cache), and/or a graph cache 121, which can be built in memory of one or more of the implementing computing devices. to various embodiments, the graph cache 121 caches edge entry information being used by the operating system.

The GOFS 109 is implemented in a kernel space of the computing system 100. GOFS commands may be transmitted to the operating system in the kernel space from the application 103 in a user space of the computing system 100 via the GOFS UI 105. According to various embodiments, a GOFS command is received by the file system command interface 106, which causes the GOFS command to be executing using a GOFS partition of the GOFS 109. Because it is implemented in the kernel space, management of the GOFS 109 and implementation of submitted GOFS command may not involve intervention of any software running in the user space.

### 3. MULTI-DEVICE IMPLEMENTATIONS OF A GRAPH-ORGANIZED FILE SYSTEM

Multiple computing devices may store data for the same graph, e.g., as part of a cloud implementation of GOFS. For example, in a distributed multi-device implementation, each device maintains a GOFS partition, which stores a portion of data for the graph in persistent storage such as persistent storage 124. Each device may store distinct portions of the graph, and/or may store at least some of the same graph data as one or more other devices. Data identifying a particular device that stores the root node, and which gnode to mount may be stored in the superblock metadata or in an external database, etc. As another example, in a multi-device implementation, multiple computing devices access the same graph data that is stored on persistent storage that is accessible by all of the multiple computing devices. In a multi-device GOFS implementation, the devices may coordinate using one or more software agents.

### 4. GOFS DATA STRUCTURES

### 4.1. GOFS Partition

According to various embodiments, the computing system 100 stores data for GOFS 109 in a GOFS partition in persistent storage (such as persistent storage 124). FIG. 1B depicts an example GOFS partition 150, which includes a superblock 153, dedicated metadata storage 156, a block bitmap 159, a gnode bitmap 162, a gnode table 165, and data blocks 168. Metadata storage 156 stores metadata for superblock 153, gnodes, and/or relationships. Gnode table 165 comprises a plurality of slots that store gnode data structures, and gnode bitmap 162 indicates which slots in gnode table 165 are occupied. Block bitmap 159 indicates which data blocks of data blocks 168 (allocated to store content data for gnodes and edge entry data structures, etc.) are occupied.

Superblock 153 of GOFS partition 150 is similar to a Unix superblock and contains overview information about the GOFS 109. Specifically, according to various embodiments, the superblock stores a size of GOFS partition 150, an identifier of a root gnode of a GOFS, a name of the root gnode, a name of GOFS partition 150, a modification timestamp for GOFS partition 150, etc. As described in further detail below, a root node of a GOFS may be changed. As such, according to various embodiments, root gnode information maintained in superblock 153 comprises a gnode identifier, where the gnode for the root node is stored with the other gnodes for the partition in gnode table 165.

### 4.2. Dedicated Metadata Storage

According to various embodiments, GOFS 109 provides one or more mechanisms for storing metadata values for properties of graph components, i.e., distinct from any content associated with the graph components. Associating graph components with metadata values allows users of GOFS 109 to encode a variety of meanings into the graph components. Given that the stored metadata values are accessible to GOFS 109 without requiring the system to access node content data, associating graph components with metadata values allows diverse inexpensive lookup functions and read entry functions, and increases the potential power of search operations performed over GOFS data.

The properties of a graph component, associated with graph component metadata values, may be anything chosen by a user, such as weight, type, genus, classification, or any other attribute of a graph component. According to various embodiments, the metadata values are stored as key-value pairs, with a property identifier as the “key” of a given key-value pair and an associated metadata value as the “value” of the key-value pair. Metadata values for properties of graph components may be stored in the dedicated metadata storage 156 (“out-of-structure” values) or in graph component data structures (“in-structure” values). The metadata values stored in dedicated metadata storage 156 are referred to as “out-of-structure” values because these values are not stored in the data structures representing the graph components, but instead are stored in the dedicated metadata storage of the GOFS partition 150.

According to various embodiments, out-of-structure metadata values are accessed based on identifiers of the graph components to which the metadata values pertain, or based on metadata identifiers stored in the data structures for the graph components, etc. For example, out-of-structure metadata values for a particular relationship are accessed using the relationship identifier for the particular relationship (which is associated with both edge entries representing the relationship, as described in further detail below), and out-of-structure metadata values for a particular node are accessible using the gnode identifier for the particular node.

According to various embodiments, GOFS 109 establishes a node metadata hash table and a relationship metadata hash table in dedicated metadata storage 156, and identifies buckets of the hash tables in which to store particular metadata values based on the identifier of the graph component associated with the metadata values. Each hash bucket includes out-of-structure metadata values for all graph components whose identifiers hash to the bucket, e.g., in a linked list of hash table entries. To illustrate, when a graph component identifier hashes to a particular bucket, an entry with out-of-structure metadata values for the graph component and an identifier of the component is added to any existing list of entries in the bucket. To retrieve the out-of-structure metadata values for the graph component, the graph component identifier is hashed to identify the bucket for the graph component, and the data structure in the bucket is traversed to identify the entry that includes the identifier of the graph component.

According to various embodiments, metadata values are stored for a relationship, which is represented by two edges. Metadata values for a relationship that relate to a single edge of the relationship may be identified in any way, e.g., by associating the metadata values with a gnode identifier identifying the source node of the pertinent edge, by associating the metadata values with an edge identifier that is unique to the pertinent edge, by creating a relationship property that is inherently associated with a particular edge of the relationship, etc.

Furthermore, the metadata space may be used to store metadata for the superblock, which are metadata values for GOFS 109 or graph itself rather than for individual graph components. For example, GOFS 109 stores key-value pairs for the superblock associated with a reserved identifier that identifies superblock metadata values, where this reserved identifier may be used to retrieve the superblock metadata values. Such metadata values may include values for a root gnode name, a root gnode identifier, extra device, extra volume manager, etc., examples of which include: nodeBitmapDevice=/dev/sdb1; BlockMapDevice=/dev/sdb2; FilesystemID=3cf81ac24c; Journal=Yes; FlushOnWrite=Yes; MetaDataIndex=RBT; and Spare VolumeData=/dev/volumes/4de8fb213ab6.

### 4.3. Gnode Data Structure

GOFS 109 maintains, in GOFS partition 150, a gnode table 165 storing a gnode data structure (“gnode”) for each node in the graph represented by GOFS 109. Nodes, represented by gnodes, may variously be associated with no data or with any kind of data, such as text data, spreadsheet data, utility data, executable data, library data, image data, video data, etc., and each node has one or more relationships to one or more other nodes.

A gnode is defined by a gnode identifier (e.g., corresponding to the slot in gnode table 165 that the gnode occupies) and contains information defining the represented node, such as content data for the node and/or pointers to data blocks in data blocks 168 storing the content data, in-structure metadata values for node properties of the node, edge entry data structures representing relationships for the node and/or pointers to data bocks in data blocks 168 storing the edge entry data structures, and potentially other information.

Examples of gnodes are described in detail in U.S. application Ser. No. 17/719,550, entitled “A GRAPH-ORGANIZED FILE SYSTEM” and filed on Apr. 13, 2022, the contents of which are incorporated by reference herein in their entirety.

### 4.4. Edge Entry Data Structure

The relationships of a GOFS are not restricted to the directory-based relationships of hierarchical file systems. According to various embodiments, the number of relationships that may be associated with a given node is unlimited, and each relationship could represent any type of relationship between nodes.

According to various embodiments, each relationship of a graph represented by GOFS partition 300 has two edges. Each edge is directional, having a source (or subject) node and a destination (or object) node. An edge whose source is a particular node is referred to herein as an outgoing edge for the source node, and an edge that identifies a particular node as the destination of the edge is referred to herein as an incoming edge for the destination node. An edge may be unidirectional and function as either an incoming edge or an outgoing edge for each node it is connected to, or an edge may be bidirectional and function as both an incoming edge and an outgoing edge for each node it is connected to.

Each edge of a graph is represented by an edge entry data structure (“edge entry”) included in or identified in the gnode representing the source node of the edge. Further, each edge entry includes a relationship identifier for the relationship represented by the edge, a gnode identifier for the destination node of the edge, and a name for the destination node of the edge. According to various embodiments, each edge entry further includes a field for metadata values for either the represented edge or for the relationship of which the represented edge is a part. These metadata values are “in-structure” metadata values given that they are stored in the edge entries themselves rather than in dedicated metadata storage 156. According to various embodiments, edge entries include references to out-of-structure metadata values, for the represented edges, within dedicated metadata storage 156.

Examples of edge entries are described in detail in U.S. application Ser. No. 17/719,550.

### 5. GRAPH-ORGANIZED FILE SYSTEM USER INTERFACE

The GOFS 109 may provide a graph-organized file system user interface (GOFS UI) 105 for accessing and manipulating data stored in the GOFS 109. The GOFS UI 105 allows a user to view a visual representation of the graph representing the GOFS 109 and the nodes and edges thereof. The GOFS UI 105 may also allow a user to view information about and/or perform various operations on the nodes and edges of the graph. User interface data representing the GOFS UI 105 may be generated by the GOFS 109 and provided to the application 103. The application 103 may use this user interface data to render the GOFS UI 105 in a display accessible to the computing system 100.

### 5.1. Origin and Workspace Views

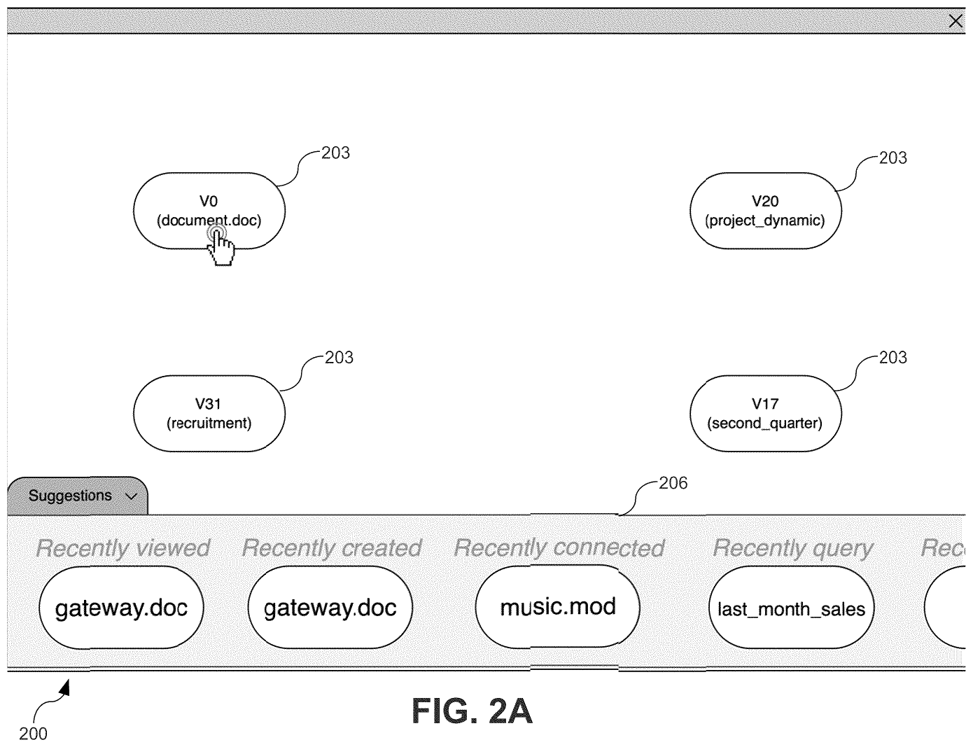

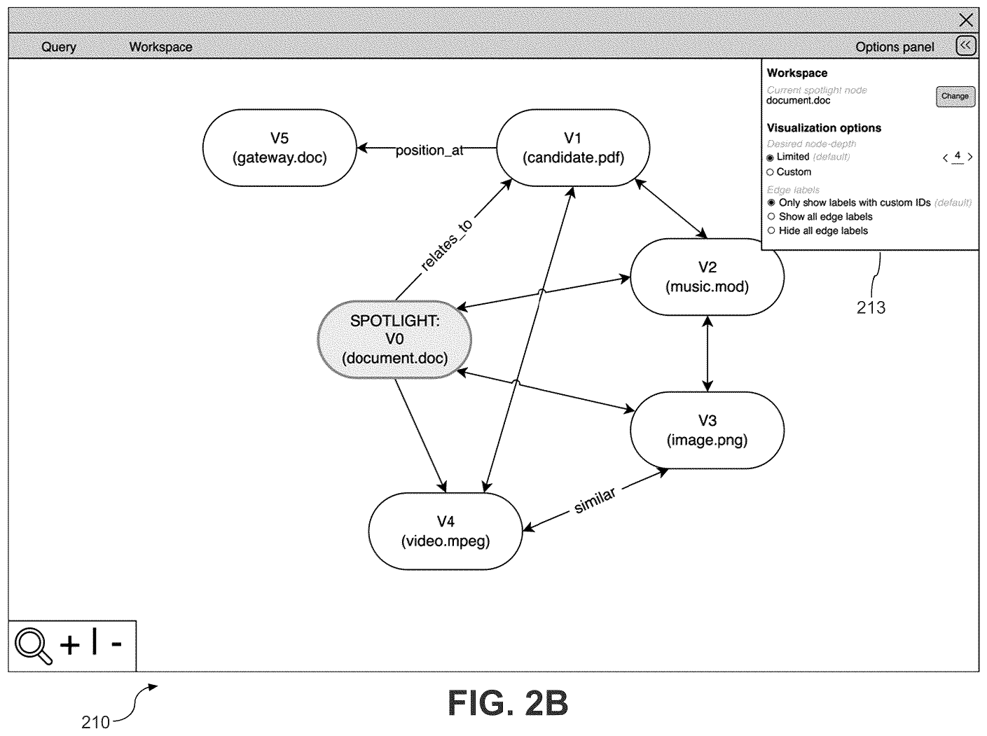

FIGS. 2A-2B illustrate examples of origin and workspace views of the GOFS UI 105, in various embodiments.

FIG. 2A illustrates an example of an origin view 200 of the GOFS UI 105. The origin view 200 may enable a user to view and select among different workspaces of the GOFS. The origin view 200 may be the first interface that a user sees upon accessing the GOFS UI 105. Considering that the GOFS 109 lacks a root directory, the origin view allows a user to find and access every workspace that the user has defined in the GOFS UI 105. Each workspace may be represented by a workspace selectable component 203 that corresponds to a spotlight node for that workspace. Selecting one of these workspace selectable components 203 causes the GOFS UI 105 to display a workspace view 210.

The origin view 200 may also allow a user to perform other actions. For example, the workspace view can include a quick access panel 206 that enables a user to directly access one or more items. The quick access panel 206 may include, for example, recently viewed nodes, recently created nodes, recently connected nodes, and recent or saved queries.

FIG. 2B illustrates an example of a workspace view 210 of the GOFS UI 105. The workspace view 210 is displayed when a user selects one of the workspace selectable components 203 in the origin view 200. The workspace view 210 displays at least a portion of the nodes associated with a workspace and the edges that connect those nodes. The nodes are depicted based on their relationship to a spotlight node selected by the user. While the workspace may include every node accessible from the spotlight node, the workspace view 210 may not display every such node at any particular time. Instead, the workspace view 210 may display nodes within a predefined “depth” from the spotlight node-that is, nodes that are accessible from the spotlight node in a number of hops that is less than or equal to a user-configurable maximum depth value.

The workspace view 210 may include an options panel 213 that enables a user to configure the depth value and desired node depth, change the workspace's spotlight node, configure which node or edge labels are displayed, and perform other actions to configure how the workspace is displayed in the workspace view 210. The options panel 213 may be hidden by interacting with a selectable component adjacent to the options panel 213, and unhidden by interacting with that same selectable component. The workspace view 210 may also offer functionality for zooming and resizing the view of the displayed nodes.

### 5.2. Performing Operations on Nodes and Edges

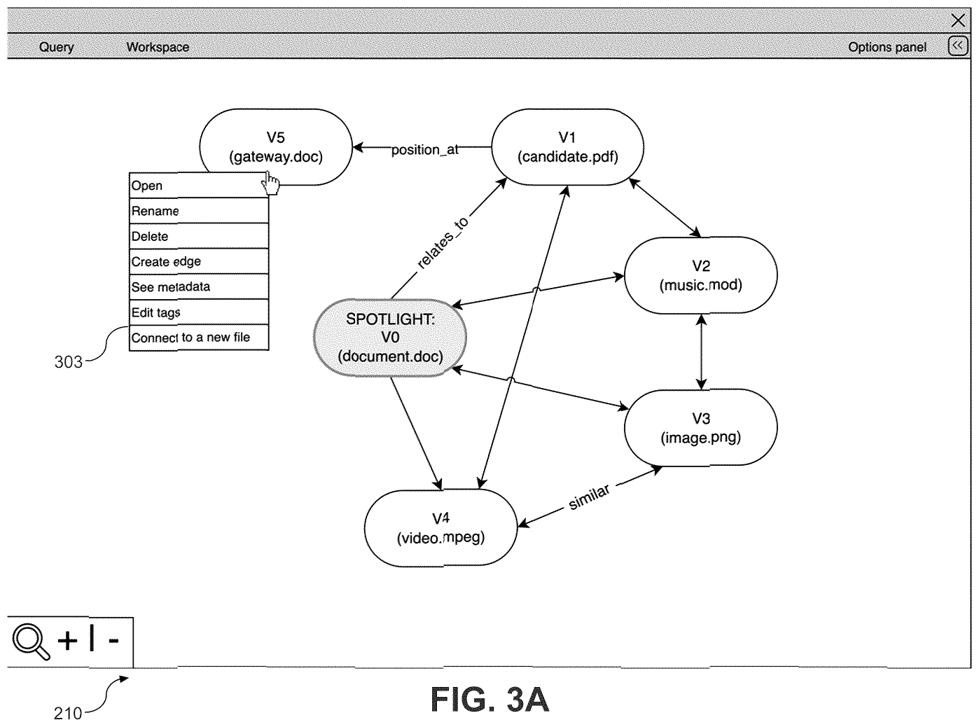

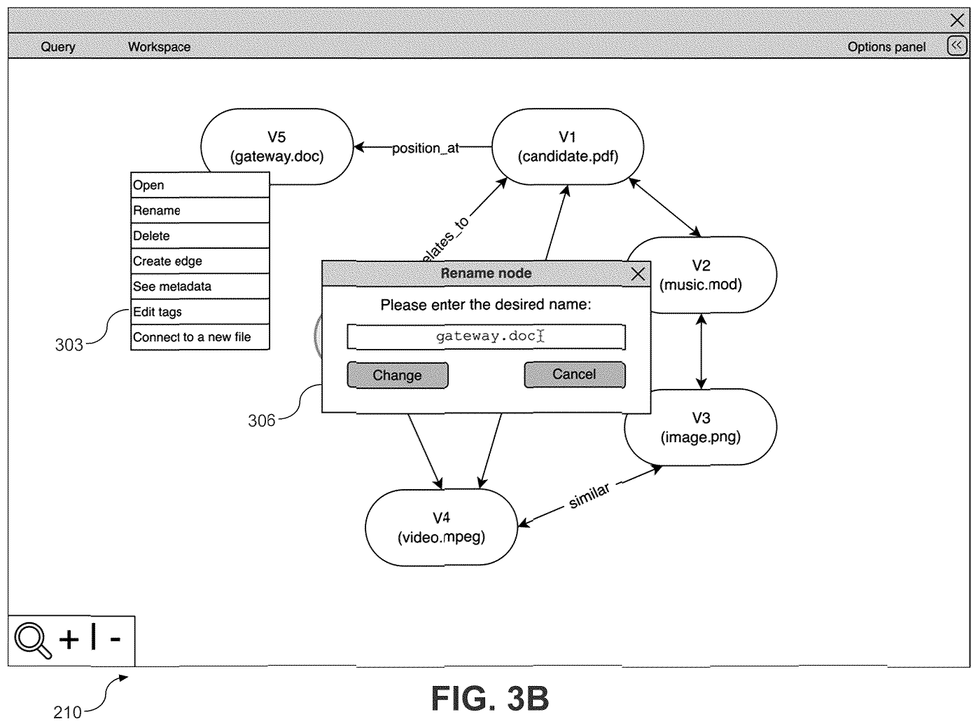

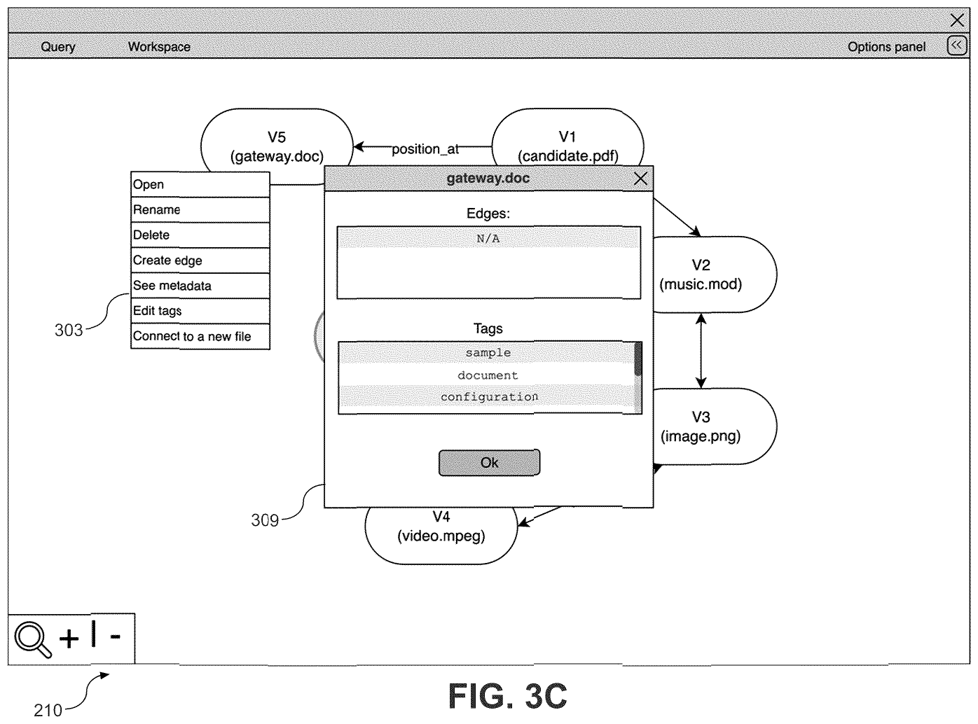

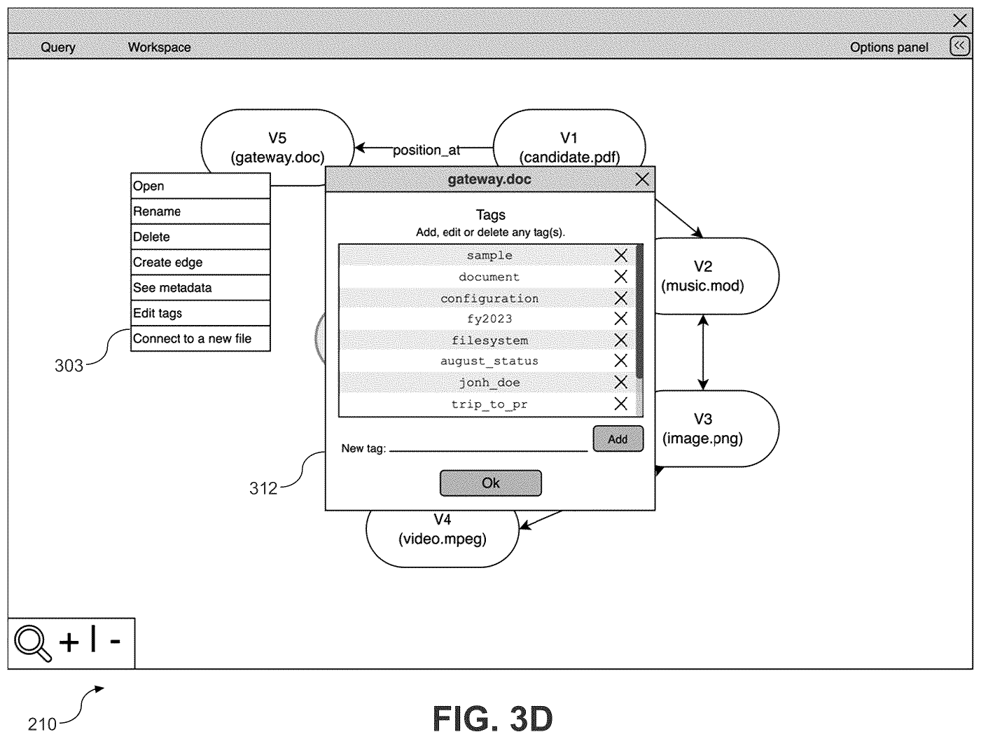

FIGS. 3A-D illustrate examples of interfaces of the GOFS UI 105 for performing operations on nodes and edges in the GOFS 109, in various embodiments. The workspace view 210 may enable users to perform various file system operations like CRUD operations on nodes, edges, or the spotlight node in particular.

FIG. 3A illustrates an example of the workspace view 210 with an example node context menu 303 for performing various operations on nodes and edges of the GOFS 109. The example node context menu 303 has been opened on a node named “gateway.doc”, so the node context menu 303 shows various options for operations that may be performed on the selected node.

The example node context menu 303 includes selectable options of operations including “Open” to open the file represented by the selected node, “Rename” to rename the selected node, “Delete” to delete the selected node, “Create edge” to create an edge connected to the selected node, “See metadata” to see metadata associated with the selected node (such as in-structure metadata values and/or out-of-structure metadata values), “Edit tags” to modify tags that are associated with the selected node, and “Connect to a new file” to connect the selected node to a new file in the GOFS 109. The operations shown in the example node context menu 303 are merely examples, however, and any file system commands and operations that can be handled by the file system command interface 106 may be included.

A similar context menu may be displayed with respect to a particular edge and therefore show various options for operations that may be performed on that particular edge. Further, any other suitable type of menu or other graphical element may be used to display operations that may be performed on a node or edge.

### 5.2.1. Renaming a Node

FIG. 3B illustrates an example of the workspace view 210 with an example renaming dialog 306 for renaming a node. The example renaming dialog 306 may allow a user to rename a selected node, such as the node on which the example node context menu 303 has been opened.

The example renaming dialog 306 may be displayed by, for example, selecting the “Rename” option in the example node context menu 303. The example renaming dialog 306 includes a text input field that allows a user to input a string to serve as the node's name in the GOFS 109.

A similar dialog box may be displayed with respect to a particular edge to allow a user to rename that particular edge. That dialog box may be accessed using, for example, a context menu for the particular edge similar to the example node context menu 303. Further, any other suitable type of dialog or other graphical element may be used to allow a user to rename a node or edge.

### 5.2.2. Viewing Metadata

FIG. 3C illustrates an example of the workspace view 210 with an example metadata window 309. The example metadata window 309 displays metadata associated with a selected node, such as the node on which the example node context menu 303 has been opened. The example metadata window 309 may be displayed by, for example, selecting the “See metadata” option in the example node context menu 303.

The metadata can include in-structure metadata values stored in a gnode associated with the selected node or out-of-structure metadata values stored in the dedicated metadata storage 156.

The example metadata window 309 in FIG. 3C shows metadata including any edges that are traversable from the selected node (although, in this example, there are no such edges) and tags associated with the selected node. The tags will be described in greater detail below.

A similar window may be displayed with respect to a particular edge to allow a user to view metadata associated with that edge, including in-structure metadata values and/or out-of-structure metadata values. That window may be accessed using, for example, a context menu for the particular edge similar to the example node context menu 303. Further, any other suitable type of graphical element may be used to display metadata associated with a node or edge.

### 5.2.3. Editing Tags

FIG. 3D illustrates an example of the workspace view 210 with an example tag editing dialog 312. The example tag editing dialog 312 allows a user to add, edit, and delete any tags associated with a selected node, such as the node on which the example node context menu 303 has been opened. The example tag editing dialog 312 may be displayed by, for example, selecting the “Edit tags” option in the example node context menu 303.

The example tag editing dialog 312 shows a list of tags associated with the selected node. The tags for a node may represent attributes of that node or the file that the node represents. Tags may identify a node and help differentiate it from other nodes. Multiple nodes may be assigned with a same tag to reflect some common attribute or property that they both possess, and nodes may be grouped based on shared tags. Tags may be user- or system-defined. The tags may represent node properties associated with in-structure metadata values or node properties associated with out-of-structure metadata values, which are described in greater detail in U.S. application Ser. No. 17/719,550.

To modify a tag in the example tag editing dialog 312, a user selects the tag in the displayed list of tags to display a dialog that allows the user to edit the name (and/or potentially other properties) of the tag. To delete a tag, a user selects a selectable component visually adjacent to the tag in the displayed list of tags. To add a new tag, the user may input a string to name the tag in a text input in the tag editing dialog 312.

A similar window may be displayed with respect to a particular edge to allow a user to edit tags associated with that edge. That window may be accessed using, for example, a context menu for the particular edge similar to the example node context menu 303. Further, any other suitable type of graphical element may be used to edit tags associated with a node or edge.

### 5.2.4. Deleting a Node

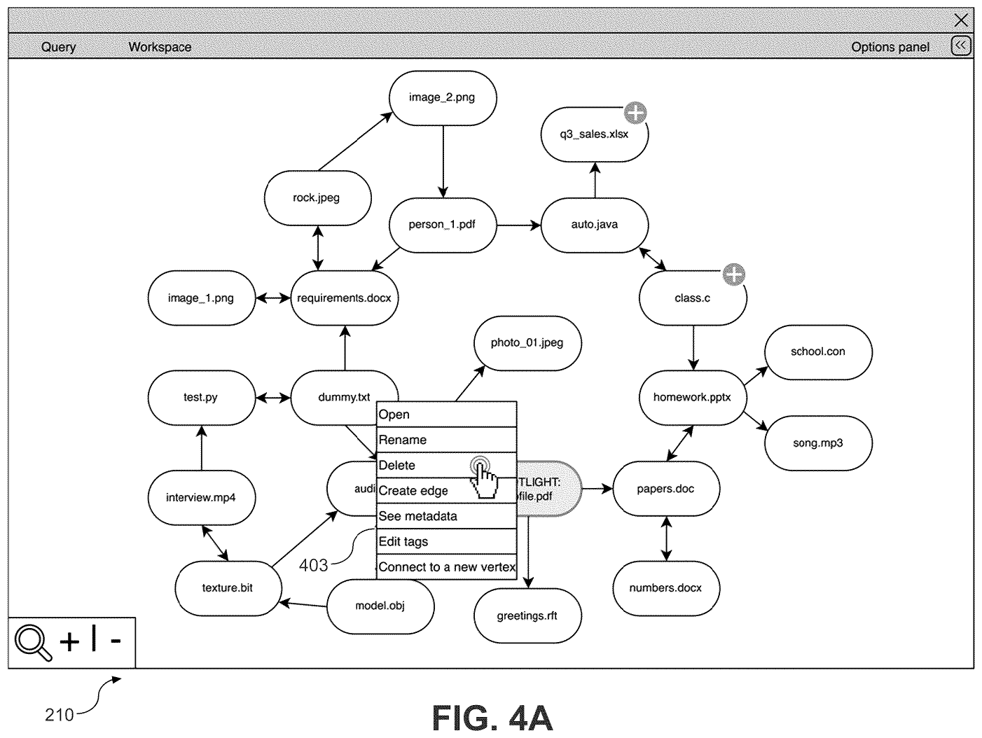

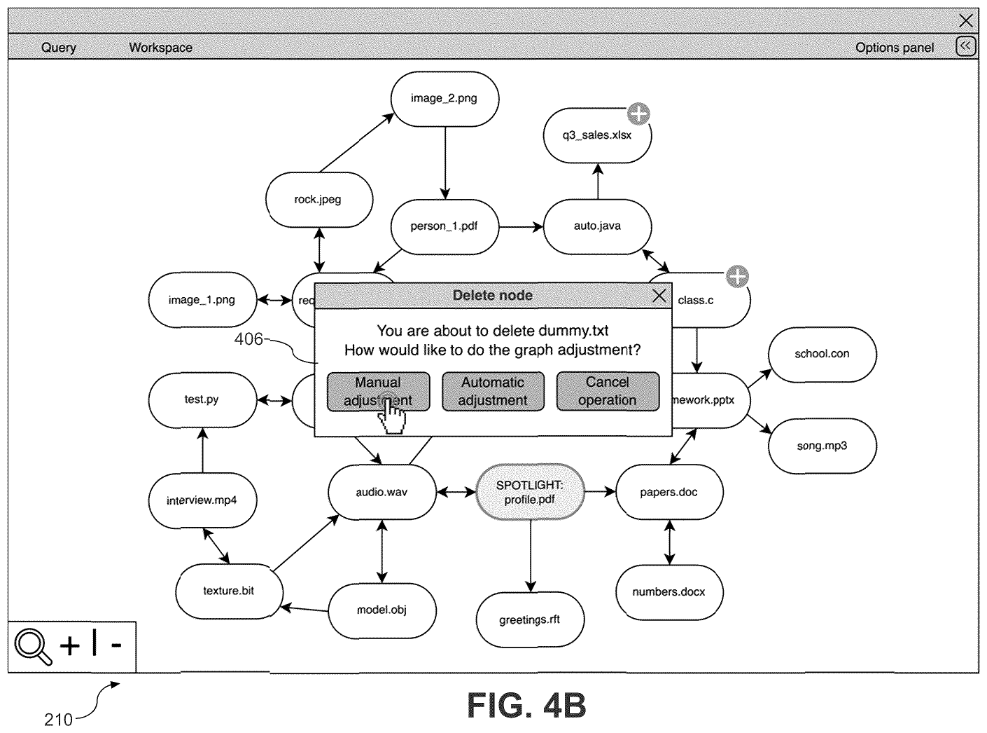

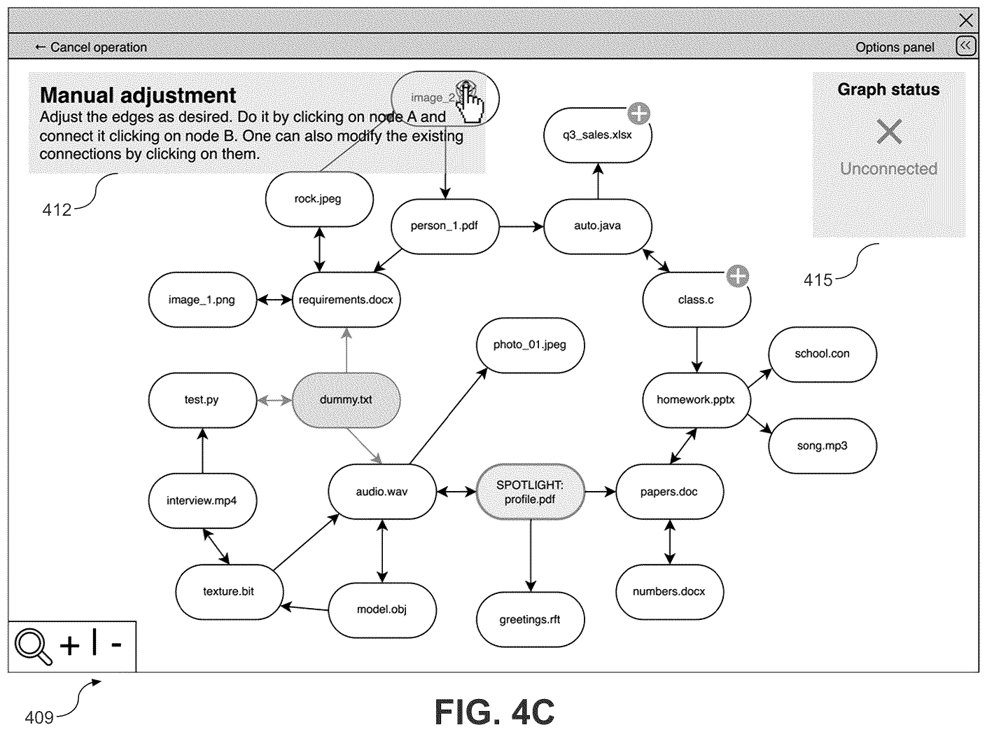

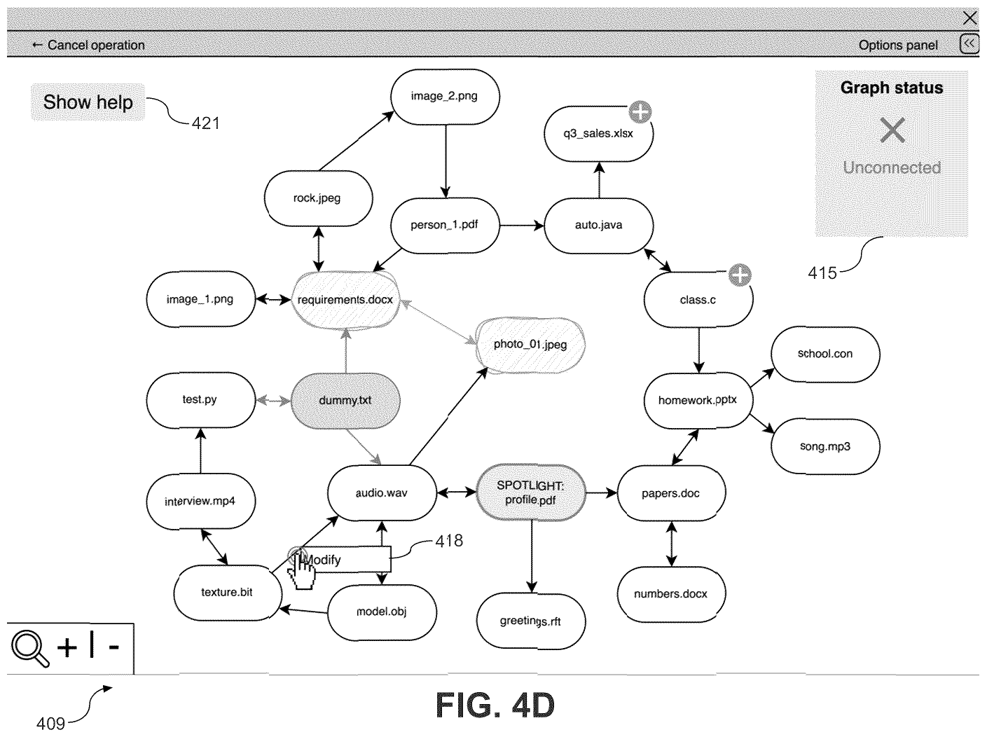

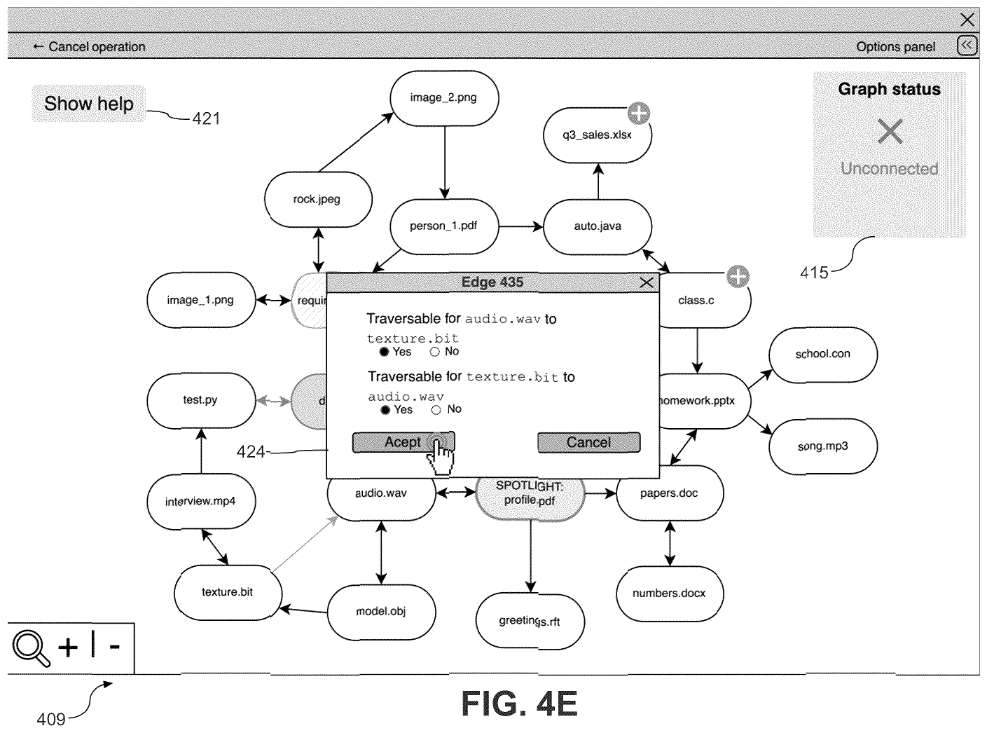

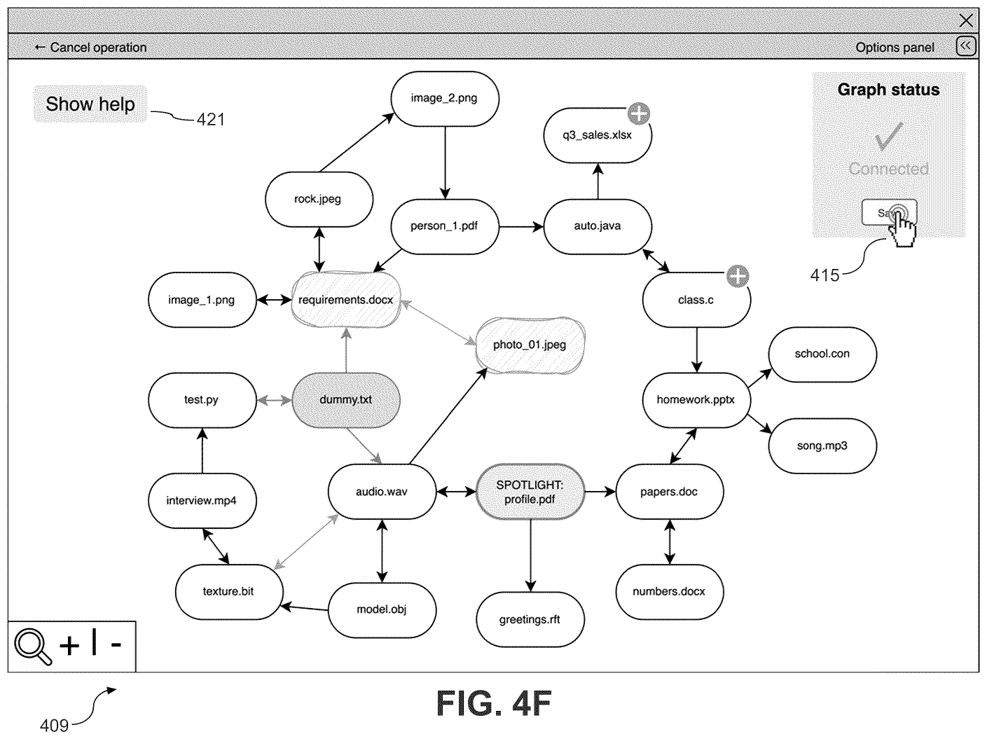

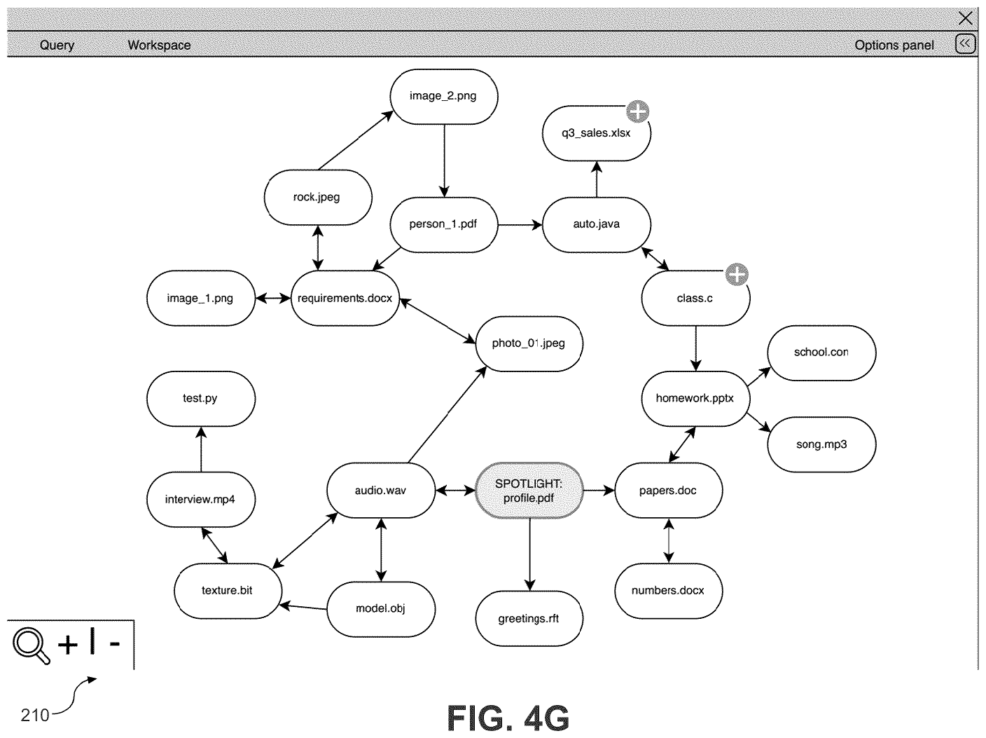

FIGS. 4A-H illustrate examples of interfaces for performing a delete operation on a node in the GOFS UI 105, in various embodiments.

FIG. 4A illustrates an example of the workspace view 210 with an example node context menu 403 similar to example node context menu 303 shown in FIGS. 3A-D. In this example, the example node context menu 403 has been opened on a node named “dummy.txt”. A user has positioned a cursor in the example node context menu 403 to select the “Delete” option. Selecting the “Delete” option will initiate an operation to delete the selected node from the GOFS 109. Deleting the selected node may remove the node and the file it represents from the GOFS 109.

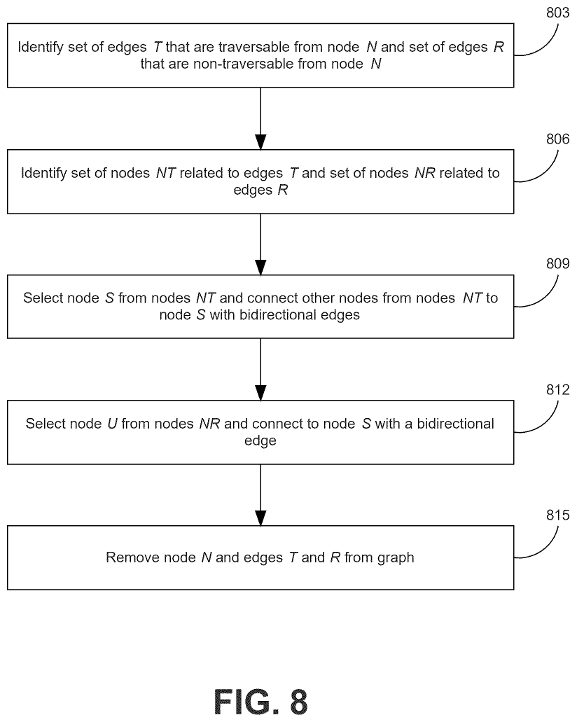

FIG. 4B illustrates an example of the workspace view 210 with an example node deletion menu 406 that allows a user to select among different processes for deleting the selected node. Each different process is represented by its own selectable component in the example node deletion menu 406. In this example, the example node deletion menu 406 includes a selectable component for “Manual adjustment” and a selectable component for “Automatic adjustment” (as well as a selectable “Cancel operation” component to cancel the delete operation). Selecting “Manual adjustment” initiates a process by which the user may adjust edges to account for the deleted node. Selecting “Automatic adjustment” initiates a process to automatically adjust edges to account for the deleted node. The manual adjustment process is described in detail in FIGS. 4C-F, while the automatic adjustment process is described in detail in FIG. 8. Both these processes may prevent the deletion from resulting in one or more “orphan nodes”. An orphan node is a node that is not accessible from the spotlight node using some path.

FIG. 4C illustrates an example of a manual adjustment interface 409 just after the manual adjustment process has begun. The manual adjustment interface 409 displays the nodes that were previously shown in the workspace view 210 before the delete operation was initiated. The manual adjustment interface 409 includes an indication of which node is to be deleted and the edges connected to that node. The manual adjustment interface 409 also presents an instruction popup 412 that instructs a user how to adjust the edges considering the node to be deleted, “dummy.txt”. The instructions popup 412 may be minimized and removed from view by interacting with a selectable component within the instructions popup 412. The manual adjustment interface 409 also allows a user to create new edges between the remaining nodes or modify existing edges. The user may also cancel the delete operation and exit the manual adjustment interface 409 to the previous workspace view 210 at any time.

The manual adjustment interface 409 may also display a connection status window 415 that indicates whether the graph is “connected”-that is, whether any nodes in the graph would be orphan nodes in the graph's current state. In this example, the connection status window 415 indicates that the graph is “unconnected”. The graph is considered unconnected because the node “person_1.pdf” and all of its neighbors except for the node “auto.java” would not be accessible from every other node if “dummy.txt” were deleted (the edge between “person_1.pdf” and “auto.java” is not an incoming edge to “person_1.pdf”, so “person_1.pdf” is not accessible from “auto.java”).

FIG. 4D illustrates an example of the manual adjustment interface 409 after the user has performed multiple operations. The manual adjustment interface 409 enables the user to perform several operations to effect adjustment of the graph. For example, a user may select a pair of nodes to create an edge between them. In this example, the nodes “requirement.docx” and “photo_01.jpeg” have been highlighted after being selected by the user, and a new bidirectional edge has been created between them. As another example, a user can select an edge to display a selectable “Modify” component 418 that allows the user to modify the selected edge, as the user has done in this example. In addition, the instructions popup 412 shown in FIG. 4C has been hidden and replaced with a selectable “Show help” component 421, which itself may be interacted with to again display the instructions popup 412.

FIG. 4E illustrates an example of the manual adjustment interface 409 with an edge modification dialog 424. The edge modification dialog 424 is displayed when the user selects the “Modify” component 418 on an edge, as shown in FIG. 4D. The edge modification dialog 424 lists the possible traversable paths between the nodes connected to the selected edge. The edge modification dialog 424 allows the user to select whether each such path will be, in fact, traversable. In this example, the user has selected a “Yes” option for both paths—the path from the node “audio.wav” to the node “texture.bit”, and the path from “texture.bit” to “audio.wav”—to make both of these paths traversable (which makes the selected edge bidirectional). Currently (before the modification has been accepted and applied to the graph), the selected edge is unidirectional such that the path from “texture.bit” to “audio.wav” is traversable and the path from “audio.wav” to “texture.bit” is not traversable. Thus, in the manual adjustment interface 409, the user has modified the traversability of the path from “audio.wav” to “texture.bit”. The user may interact with selectable components to accept the edge modification or to cancel the edge modification operation.

FIG. 4F illustrates an example of the manual adjustment interface 409 following the operations described in FIGS. 4D-E. The edge that was selected for modification in FIG. 4E has been modified to be bidirectional. In addition, the connection status window 415 now indicates that the graph is “Connected”, meaning that there would be no orphan nodes if the operations discussed above were applied to the graph. The connection status window 415 also includes a selectable “Save” component that allows a user to apply those operations to the graph and exit the manual adjustment interface 409.

FIG. 4G illustrates an example of the workspace view 210 after the node deletion and manual adjustment process described in FIGS. 4B-F. The workspace view 210 is again displayed after exiting the manual adjustment interface 409. In this example, the “dummy.txt” node has been deleted and thus removed from the graph. The graph also now includes the edge between nodes “requirements.docx” and “photo_01.jpeg” that was created in the manual adjustment interface 409. Likewise, the edge between “audio.wav” and “texture.bit” is now shown as bidirectional following the modification of that edge in the manual adjustment interface 409.

### 5.2.5. Deleting an Edge

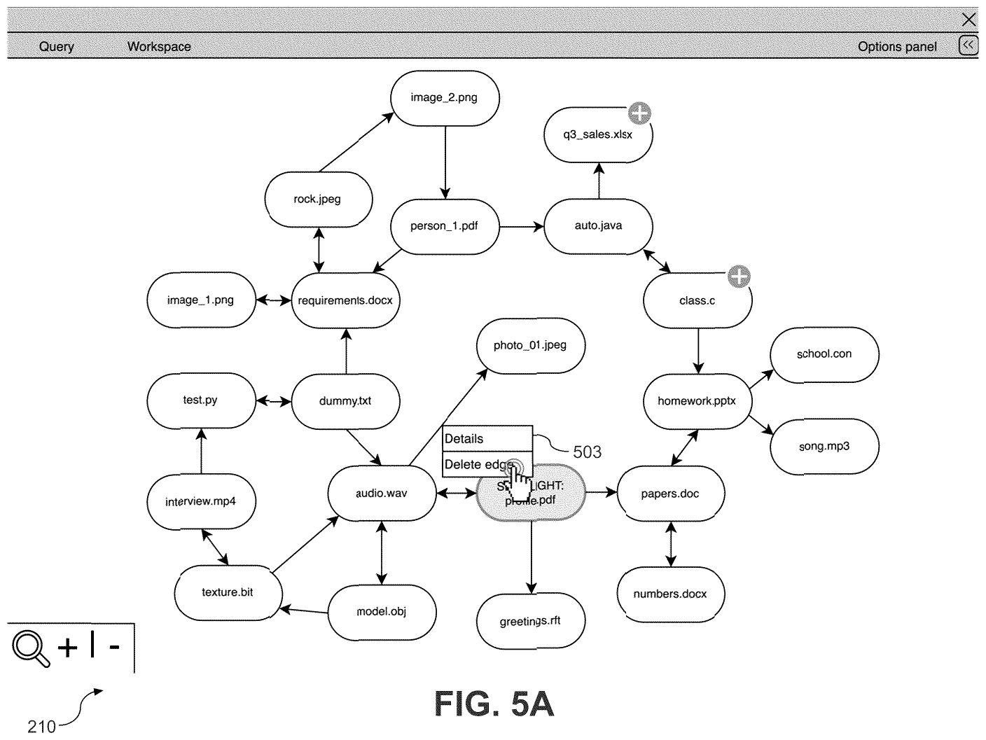

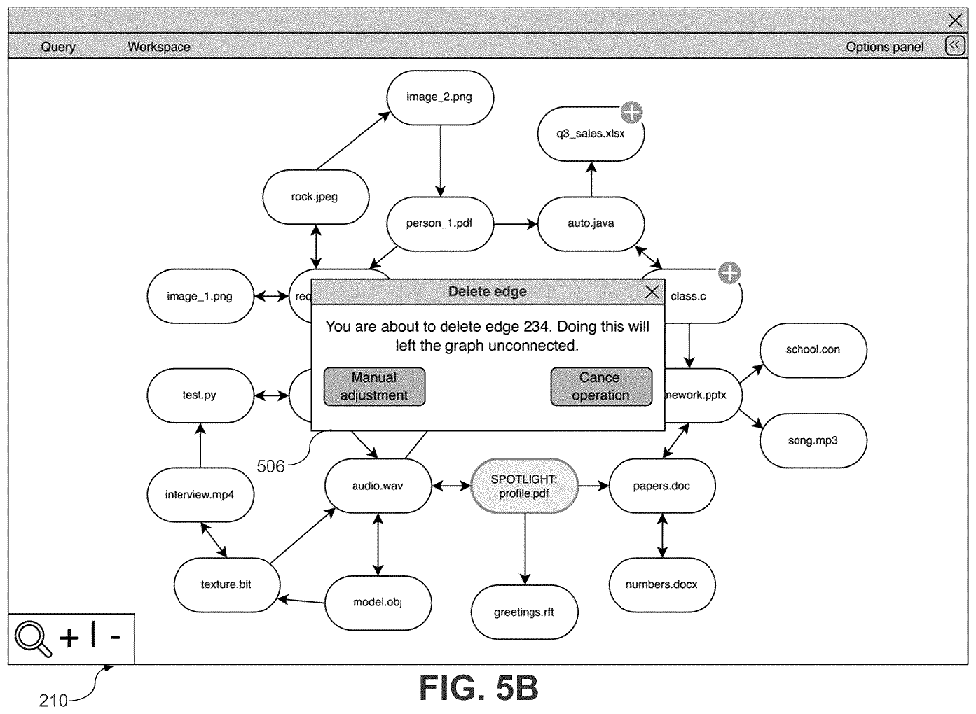

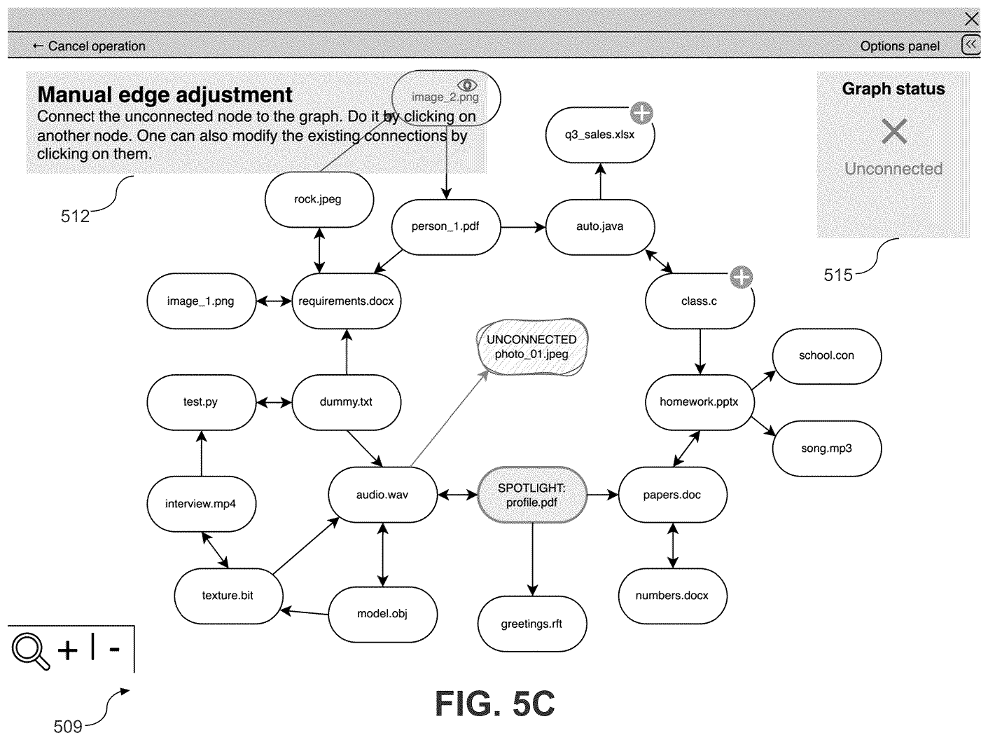

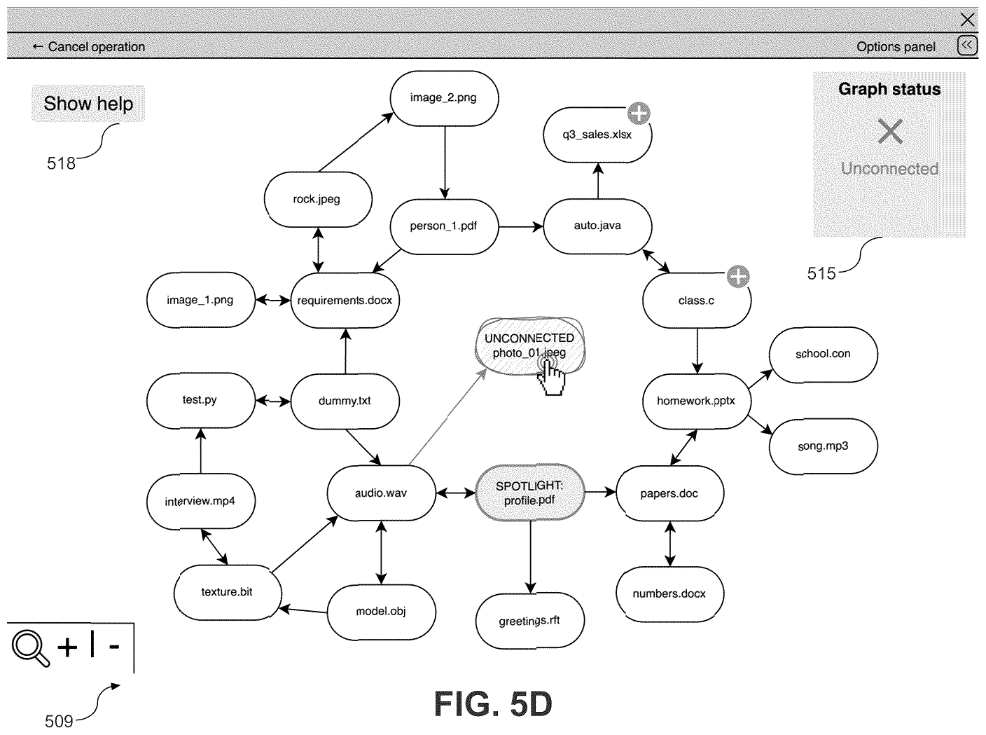

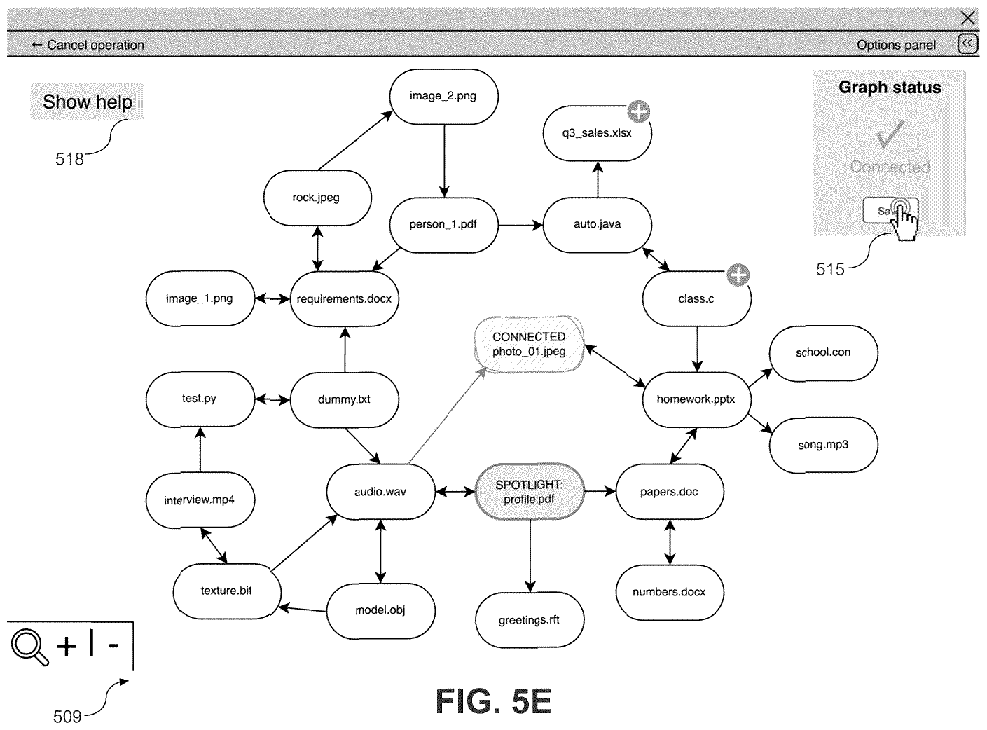

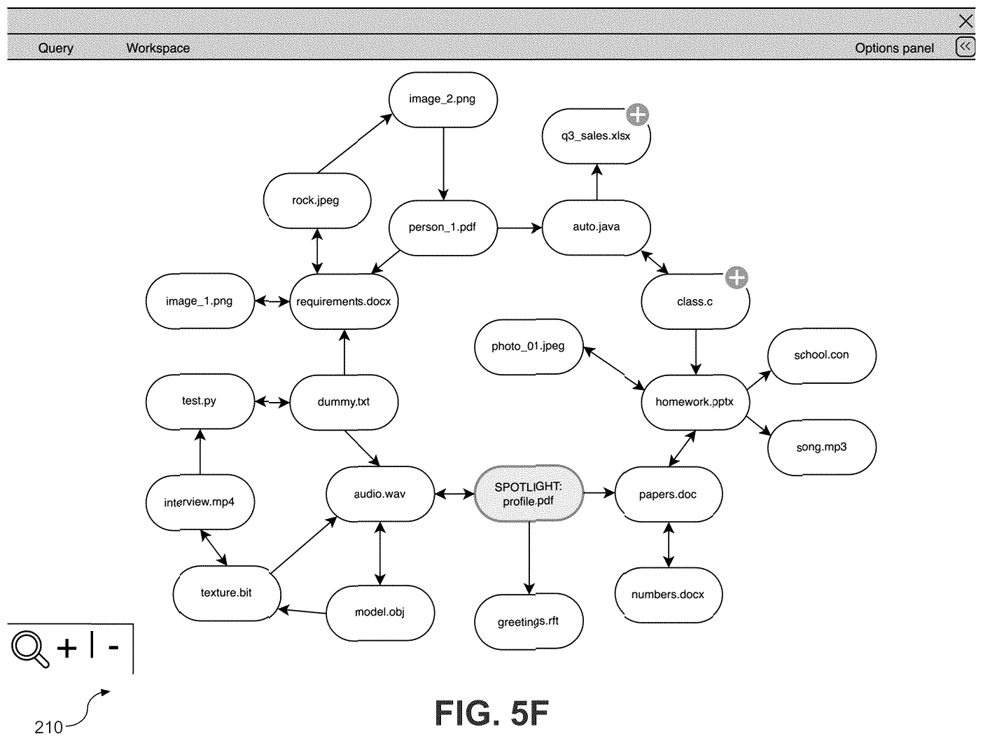

FIGS. 5A-F illustrate examples of interfaces for performing a delete operation on an edge in the GOFS UI 105, in various embodiments.

FIG. 5A illustrates an example of the workspace view 210 with an edge context menu 503. The edge context menu 503 is displayed when a user selects an edge. The edge context menu 503 includes a list of operations that may be performed with respect to the selected edge. In this example, the operations include a “Details” option to view information about the selected edge and a “Delete edge” option to initiate an operation to delete the selected edge

FIG. 5B illustrates an example of the workspace view 210 with an example edge deletion menu 506. The example edge deletion menu 506 includes a selectable “Manual adjustment” component to begin the manual edge adjustment process and a selectable “Cancel operation” component to cancel the edge delete operation. As described with relation to the manual adjustment process during node deletion, the manual edge adjustment process may enable a user to adjust edges in the graph to prevent any orphan nodes that would otherwise result from the edge deletion.

FIG. 5C illustrates an example of a manual edge adjustment interface 509. The manual edge adjustment interface 509 displays the nodes that were previously shown in the workspace view 210 before the edge delete operation was initiated. The manual edge adjustment interface 509 includes an indication of which edge is to be deleted, as well as any node that would become an orphan node if the selected edge were deleted. In this case, the selected edge and the node “photo_01.jpeg” are highlighted, and “photo_01.jpeg” includes a text label indicating that it would be “UNCONNECTED” if the edge delete operation were carried out. “photo_01.jpeg” would become an orphan node because, without the selected edge, the node would be inaccessible from every other node in the graph. The manual edge adjustment interface 509 also presents an instructions popup 512 that instructs a user how to adjust the edges considering the edge to be deleted. The instructions popup 512 may be minimized and removed from view by interacting with a selectable component within the instructions popup 512. The manual edge adjustment interface 509 also allows a user to create new edges between the remaining nodes or modify existing edges. The user may also cancel the delete operation and exit the manual edge adjustment interface 509 to the previous workspace view 210 at any time.

The manual edge adjustment interface 509 may also display a connection status window 515 that indicates whether the graph is “connected”-that is, whether any nodes in the graph would be orphan nodes in the graph's current state. In this example, the connection status window 515 indicates that the graph is “unconnected”. The graph is considered unconnected because the node “photo_01.jpeg” would become an orphan node if the selected edge were deleted.

FIG. 5D illustrates an example of the manual edge adjustment interface 509 after the user has selected a node to reconnect. The manual edge adjustment interface 509 enables the user to reconnect any node that might become an orphan node with other nodes in the graph. In this example, the user has selected the node “photo_01.jpeg” for reconnection. The user can then select another node in the graph to create an edge between the two selected nodes. In addition, the instructions popup 512 shown in FIG. 5C has been hidden and replaced with a selectable “Show help” component 518, which itself may be interacted with to again display the instructions popup 512.

FIG. 5E illustrates an example of the manual edge adjustment interface 509 after the creation of a new edge connected to “photo_01.jpeg”. After selecting “photo_01.jpeg” for reconnection as shown in FIG. 5D, the user then selected the node “homework.pptx”. This resulted in a new, bidirectional edge being created between the two nodes. The traversability of this edge may be modified in a similar manner to the edge modification process described in FIG. 4E above. In addition, the connection status window 515 now indicates that the graph is “Connected”, meaning that there would be no orphan nodes if the edge deletion and reconnection operations were applied to the graph. Likewise, “photo_01.jpeg” now includes a label indicating that it is “CONNECTED” and would no longer be an orphan node. The connection status window 515 also includes a selectable “Save” component that allows a user to apply those operations to the graph and exit the manual edge adjustment interface 509.

FIG. 5F illustrates an example of the workspace view 210 after the node deletion and manual adjustment process described in FIGS. 5B-E. The workspace view 210 is again displayed after exiting the manual edge adjustment interface 509. In this example, the edge between nodes “audio.wav” and “photo_01.jpeg” has been deleted and thus removed from the graph. The graph also now includes the edge between nodes “photo_01.jpeg” and “homework.pptx” that was created in the manual edge adjustment interface 509.

### 5.3. Configuring Node Visualization Depth

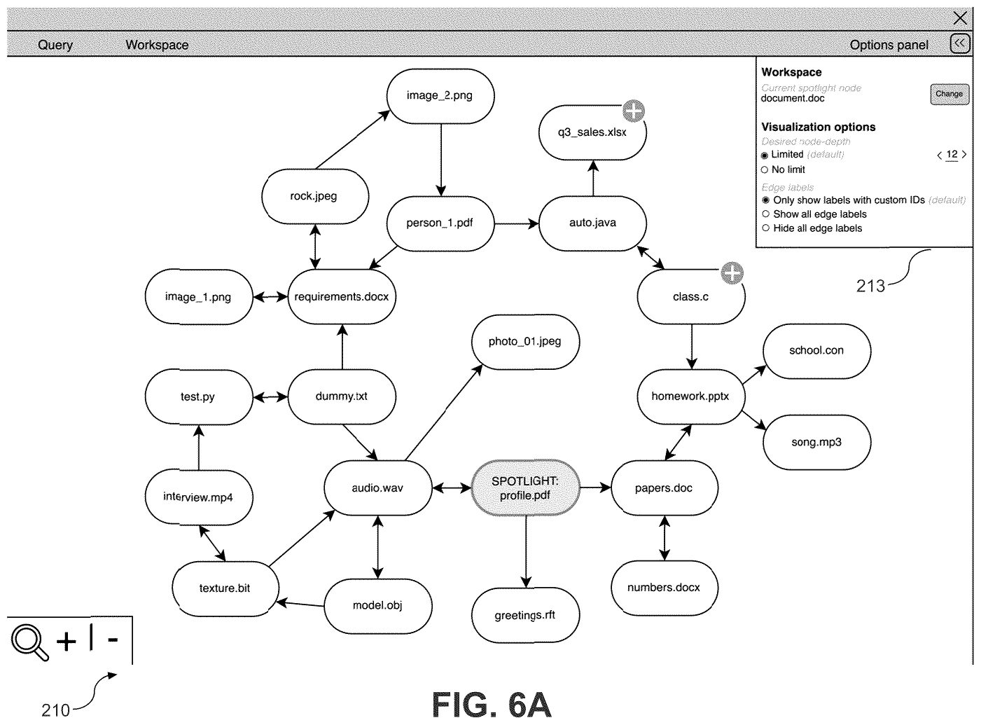

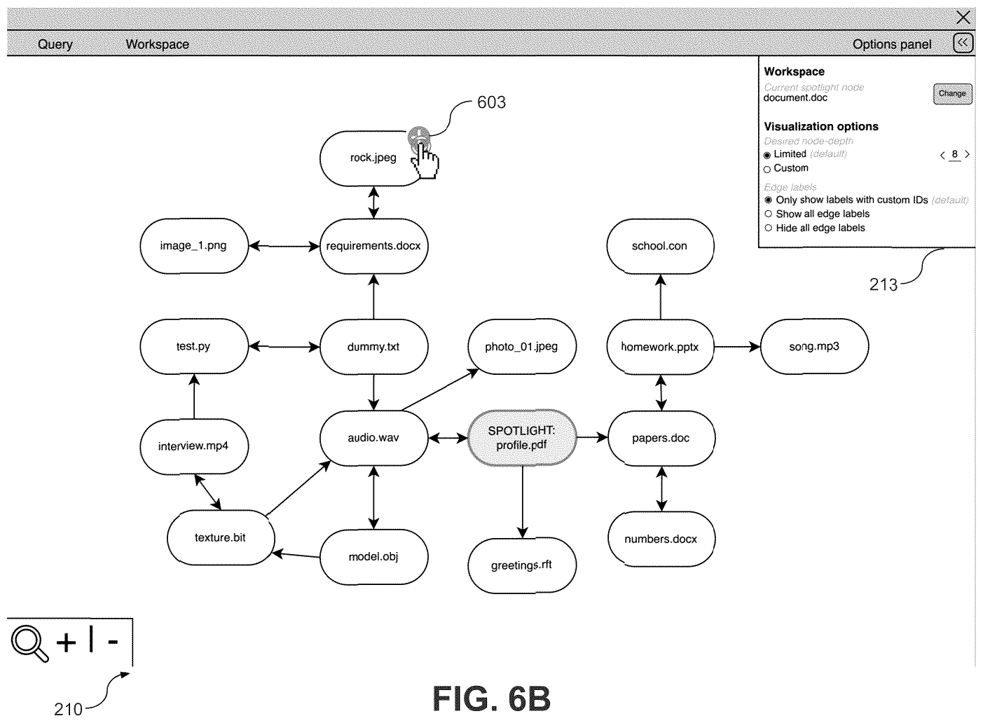

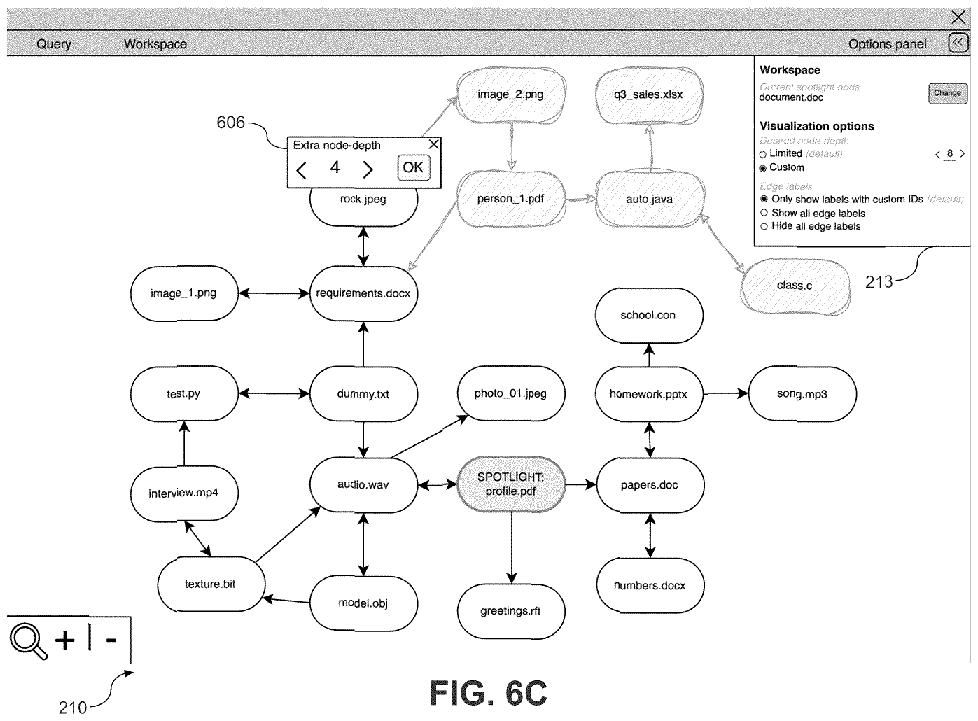

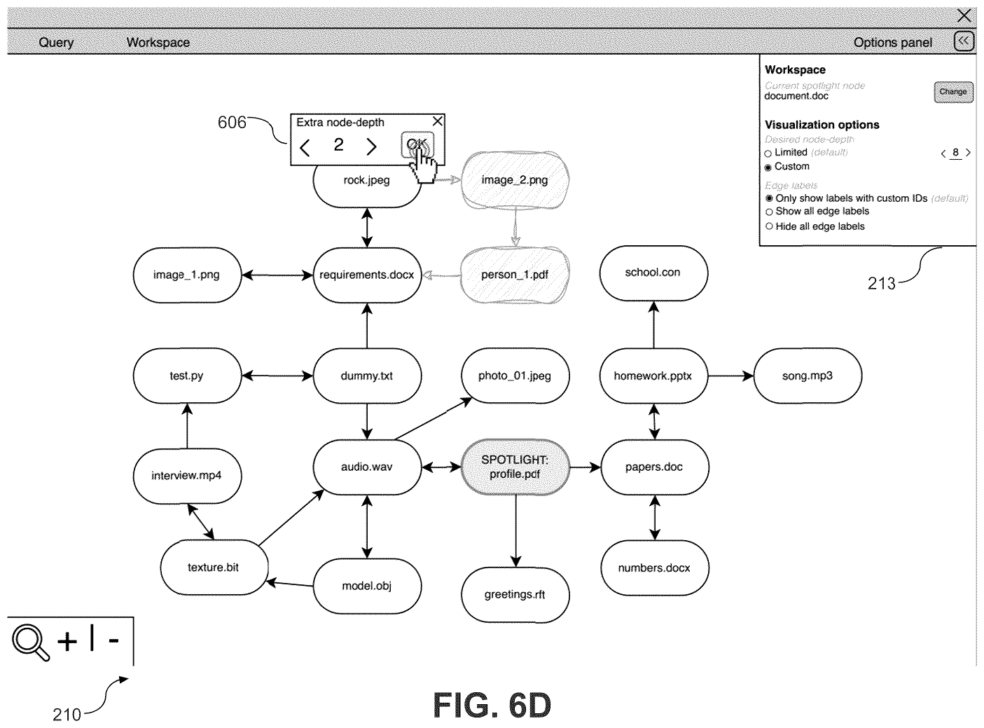

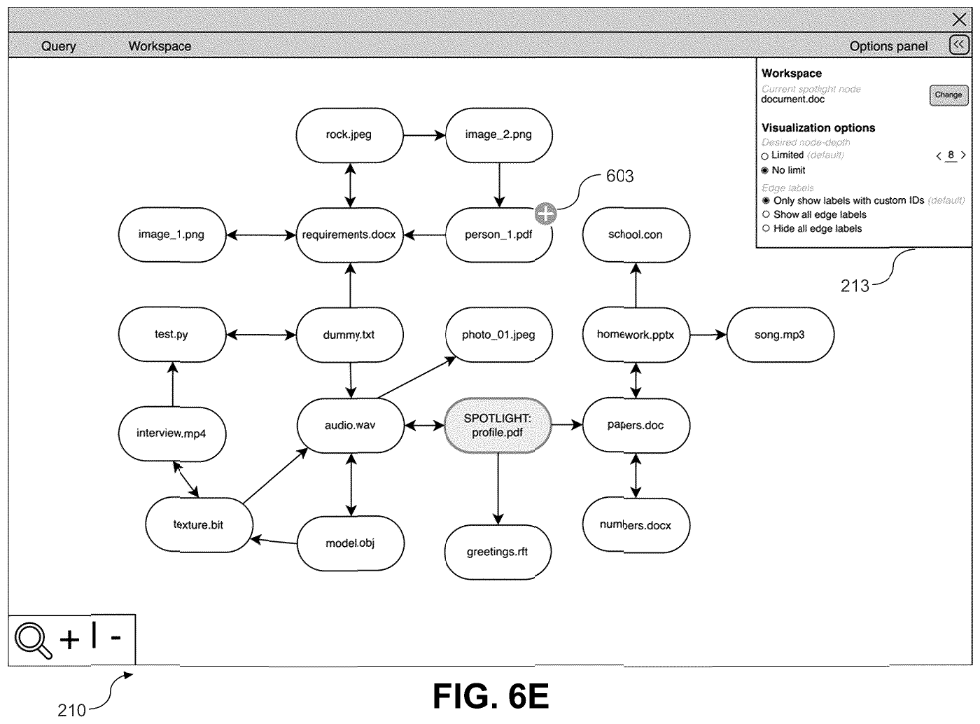

FIGS. 6A-E illustrate examples of interfaces for configuring node visualization depth in the GOFS UI 105, in various embodiments.

FIG. 6A illustrates an example of the workspace view 210 with the options panel 213 displayed. As discussed above, the options panel 213 enables a user to configure how nodes in the selected workspace are displayed in the workspace view 210. As an example, the options panel 213 may enable a user to configure the node visualization depth of the workspace view 210. The node visualization depth affects what nodes are displayed in the workspace view 210 based on their distance in hops from the spotlight node. The options panel allows the user to select a “Limited” node visualization depth or a “No limit” node visualization depth. If the user selects “No limit”, the workspace view 210 will display all nodes in the graph, no matter their distance from the spotlight node. If the user selects “Limited”, the workspace view 210 will display only nodes having a distance from the spotlight node that is less than or equal to a user-defined node visualization depth value. The options panel 213 enables the user to configure this value. In this example, the node visualization depth value is set to “12”, so the workspace view 210 will display only nodes that are 12 hops or fewer from the spotlight node.

FIG. 6B illustrates an example of the workspace view 210 with a selectable node expansion component 603. A node expansion component 603 may be displayed in association with a particular node. A user may interact with the node expansion component 603 to increase the node visualization depth with respect to the particular node. That is, interacting with the node expansion component 603 may cause the workspace view 210 to display one or more “extra” nodes that are connected to the particular node, even if those nodes are not within the workspace-wide node depth visualization value that is configurable in the options panel 213. Here, the node expansion component 603 is displayed in association with the node “rock.jpeg”, so selecting the node expansion component 603 would display extra nodes based on their distance from “rock.jpeg”.

FIG. 6C illustrates an example of the workspace view 210 after the user has interacted with the node expansion component 603 shown in FIG. 6B. Interacting with the node expansion component 603 causes display of an extra node-depth configuration dialog 606. The extra node-depth configuration dialog 606 includes a configurable value that sets an extra node visualization depth with respect to the particular node. In this example, the extra node visualization depth value has been set to “4”, so nodes with a distance of four hops or fewer from the node “rock.jpeg” are displayed, even though they are not within the workspace-wide node visualization depth configured in the options panel 213. Those “extra” nodes are highlighted within the workspace view 210 to be distinguishable from other nodes in the workspace view 210. Edges connecting those extra nodes to other nodes displayed in the workspace view 210 may likewise be displayed. This includes edges connecting an extra node to a previously-displayed node other than “rock.jpeg”, such as the edge that connects node “person_1.pdf” to node “requirements.docx”.

FIG. 6D illustrates another example of the workspace view 210 after the user has interacted with the node expansion component 603 shown in FIG. 6B. In this example, the extra node visualization depth has been decreased from “4” to “2” in the extra node-depth configuration dialog 606. Thus, the workspace view 210 displays nodes having a distance from the node “rock.jpeg” of two hops or fewer that would otherwise not be displayed. The extra node-depth configuration dialog 606 further includes a selectable component to apply the set extra node visualization depth to the graph, which the user has positioned a cursor over in this example.

FIG. 6E illustrates an example of the workspace view 210 after the extra node visualization depth configured in FIG. 6D has been applied. Here, the workspace view 210 shows the extra nodes displayed as a result of the extra node visualization depth as a part of the graph, even if they are not in the workspace-wide node visualization depth. A node expansion component 603 is also displayed in association with the node “person_1.pdf”, which would enable the user to display additional nodes based on their distance from “person_1.pdf”.

### 5.4. Performing Queries

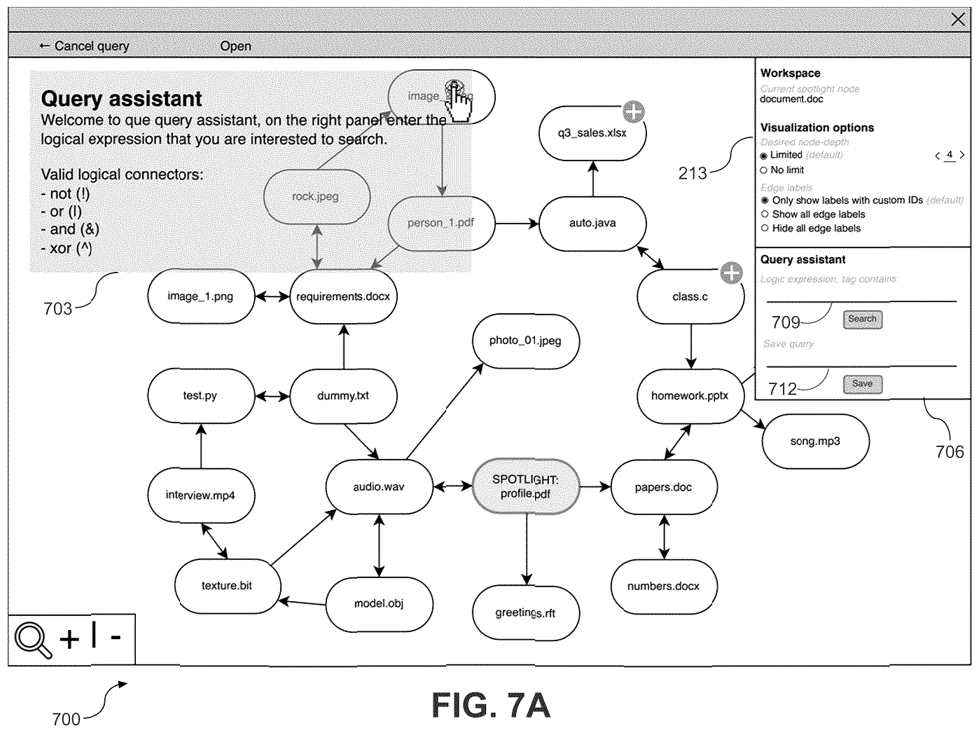

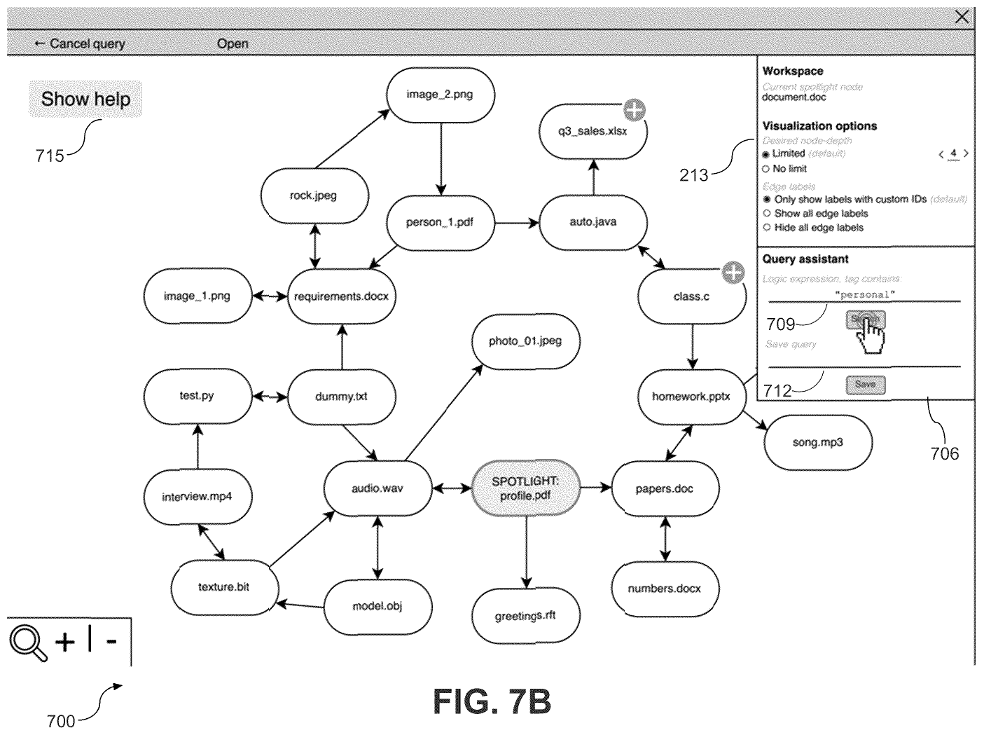

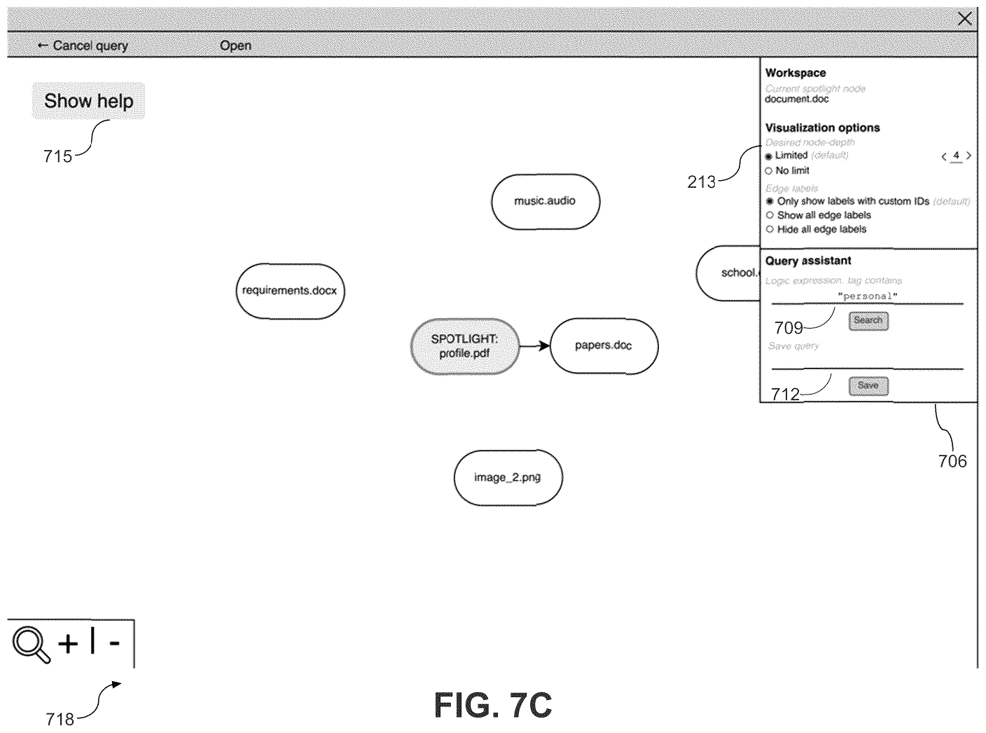

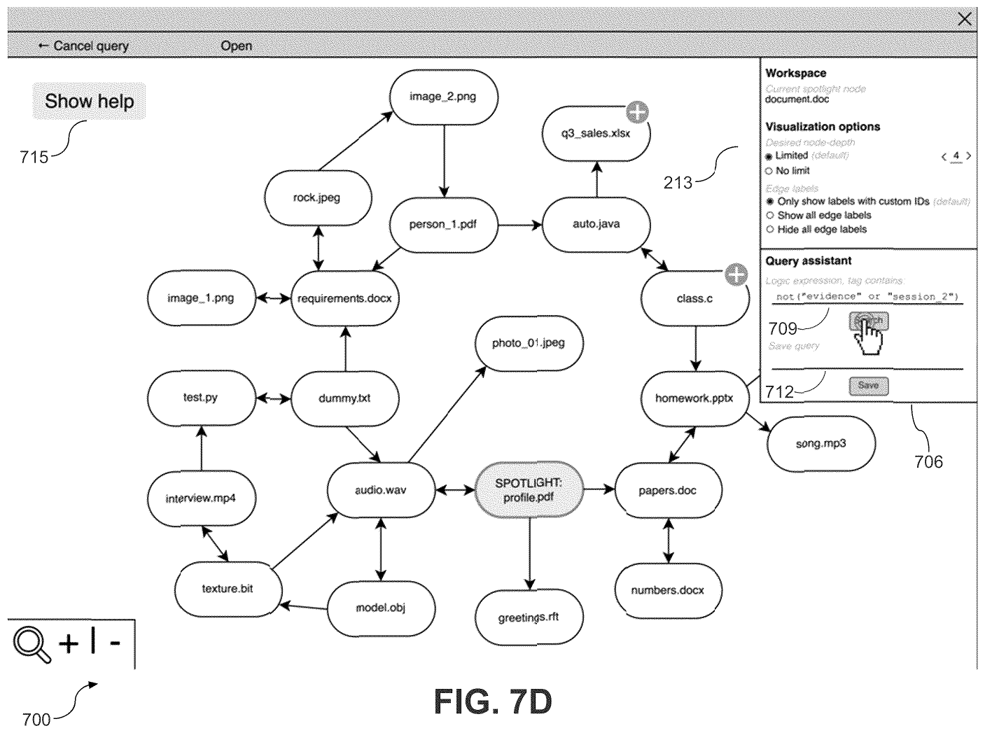

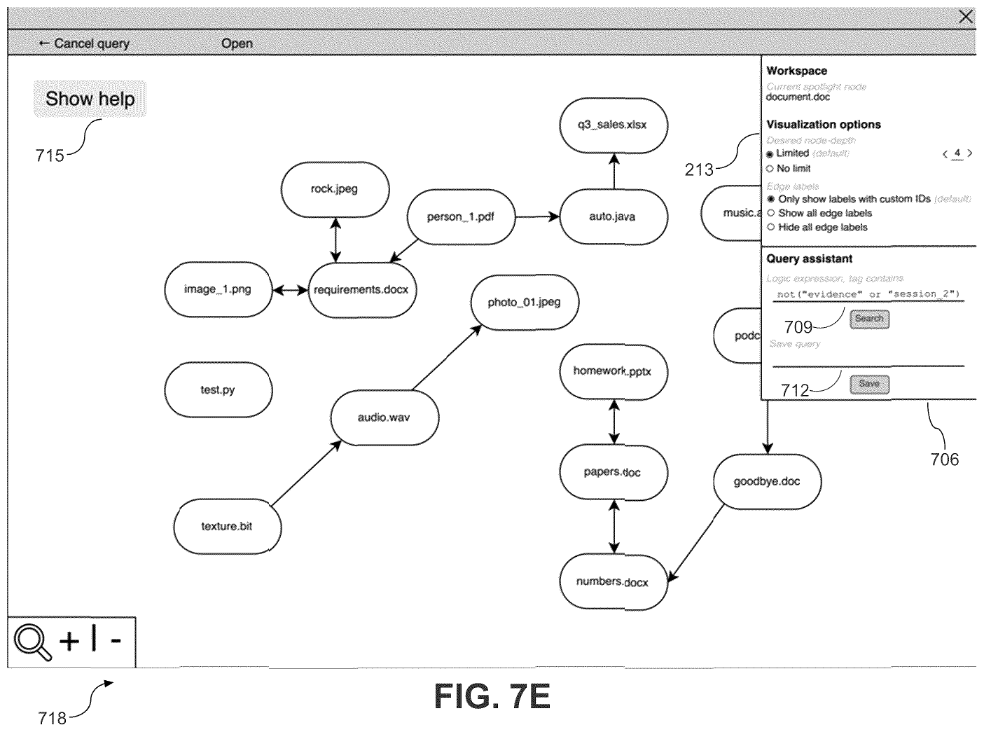

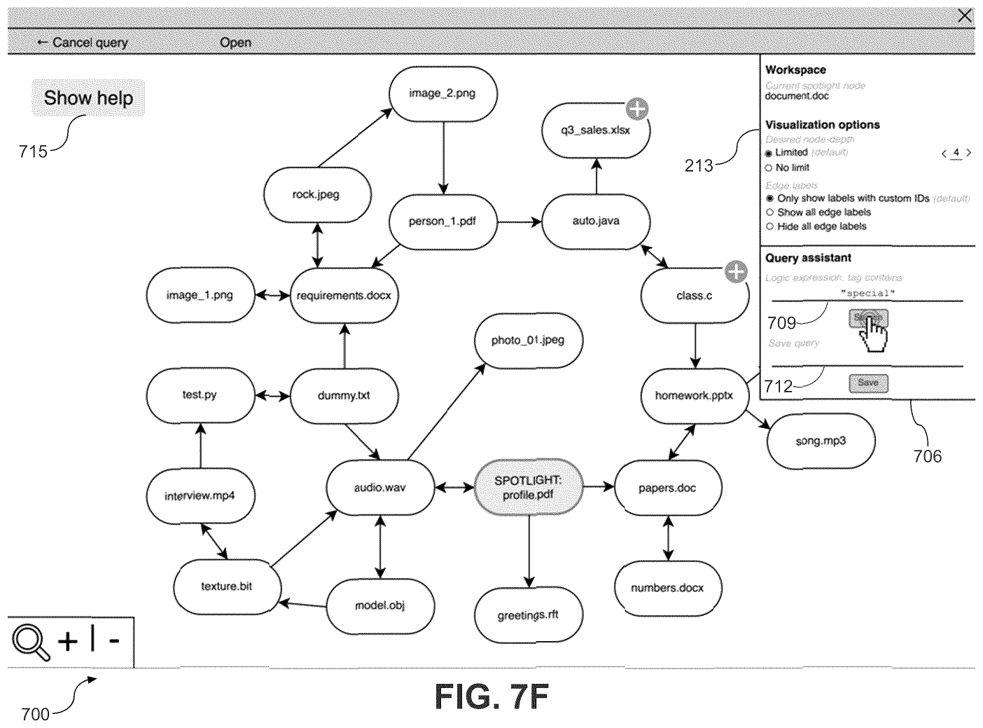

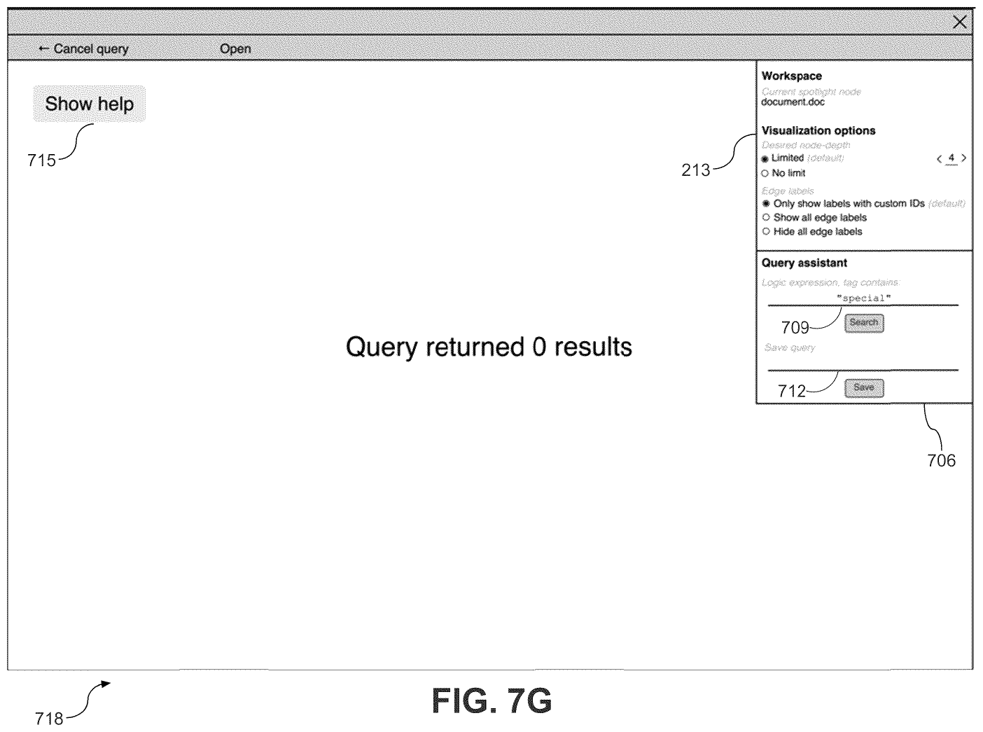

FIGS. 7A-G illustrate examples of interfaces for performing queries in the GOFS UI 105, in various embodiments.

FIG. 7A illustrates an example of a query interface 700. The query interface 700 enables a user to perform search operations over the graph represented by GOFS partition 150. The query interface 700 includes an instructions popup 703 that instructs a user how to execute a query over the graph. The instructions popup 703 may be hidden by interacting with a selectable component within the instructions popup 703. The query interface 700 further includes a query assistant panel 706 having a search input field 709 and a save input field 712. The save input field 712 enables a user to save a query for later use.

The search input field 709 enables the user to enter a query expression and execute a search of the graph for nodes having tags that satisfy the logical expression. Permissible logic connectors and potentially other syntax that may be used in the query expression may be shown in the instructions popup 703.

The search operation may be performed based on tags representing particular node properties associated with in-structure metadata values or node properties associated with out-of-structure metadata values. Thus, the search may be conducted over the graph component data structures representing the nodes of the graph (or over the graph cache 246 or other cache if the in-structure metadata values have been loaded into such a cache) and/or over the dedicated metadata storage 156. Such search operations may be performed by the GOFS 109 or application 103. Search operations in a GOFS are described in greater detail in U.S. application Ser. No. 17/719,550.

FIG. 7B illustrates an example of the query interface 700 in which the user has entered a query expression to search. In this example, the entered string “personal” in the search input field 709. Interacting with the selectable “Search” component below the search input field 709 will cause the GOFS 109 or application 103 to search the graph for nodes having tags that match the string “personal”. In addition, the instructions popup 703 shown in FIG. 7A has been hidden and replaced with a selectable “Show help” component 715, which itself may be interacted with to again display the instructions popup 703.

FIG. 7C illustrates an example of a results screen 718. The results screen 718 is displayed after initiating a search by entering a query expression in the search input field 709 and interacting with the “Search” component. The results screen 718 displays the results of searching the graph for nodes having tags that match the search string. The results may include all such nodes, as well as any edges that connect those nodes to each other. In this example, the results screen 718 includes results of the search initiated in FIG. 7B. The results screen 718 includes nodes having tags that match the query expression in the string “personal”. The results screen 718 also displays an edge that connects the nodes “profile.pdf” and “papers.doc”, both of which were returned as a result of the search.

FIG. 7D illustrates an example of the query interface 700 in which the user has entered a query expression to search. In this example, entered the string “not (‘evidence’ or ‘session_2’)” in the search input field 709. Interacting with the selectable “Search” component below the search input field 709 will cause the GOFS 109 or application 103 to search the graph for nodes having tags that satisfy that query expression-that is, nodes that do not have tags matching the string “evidence” and/or the string “session_2”.

FIG. 7E illustrates another example of a results screen 718. In this example, the results screen 718 includes results of the search initiated in FIG. 7D. The results screen 718 includes nodes having tags that match the query expression in the string “not (‘evidence’ or ‘session_2’)”. The results screen 718 also displays several edges that connect the various nodes that were returned as results of the search.

FIG. 7F illustrates an example of the query interface 700 in which the user has entered a logical expression to search. In this example, entered the string “special” in the search input field 709. Interacting with the selectable “Search” component below the search input field 709 will cause the GOFS 109 or application 103 to search the graph for nodes having tags that match the string “special”.

FIG. 7G illustrates another example of a results screen 718. In this example, the results screen 718 includes results of the search initiated in FIG. 7F. The results screen 718 includes nodes having tags that match the query expression in the string “special”. However, no such node exists in the graph, so the search screen instead displays a message indicating that the query returned no results.

In some implementations, the GOFS UI 105 may present similar interfaces as described in FIGS. 7A-G above to enable queries over edges in the GOFS 109, such as search operations performed based on tags associated with edges.

### 6. EXAMPLE PROCESS FOR AUTOMATICALLY DELETING A NODE

FIG. 8 is a flow diagram that illustrates an example process for automatically deleting a node in the GOFS UI 105, in an embodiment. The flow diagram of FIG. 8 provides merely an example of the many different types of functional arrangements that may be employed to implement the operation of the depicted portion of the GOFS 109. And while the functionality discussed in FIG. 8 is described as being performed by the GOFS 109, this functionality may alternatively be performed by the application 103. As another alternative, the flow diagram of FIG. 8 may be viewed as depicting an example of elements of a method implemented within the computing system 100.

At step 803, the GOFS 109 identifies a set of edges T that are traversable from a node N, and a set of edges R that are non-traversable from node N. Node N is the node to be deleted. The user may select node N for deletion by, for example, selecting node N in the workspace view 210 and selecting a “Delete” option from the resulting menu. The user may then initiate the process for automatically deleting node N by selecting an option for “Automatic adjustment” in the node deletion menu. Each edge in set of edges T is a unidirectional edge outgoing from node N or a bidirectional edge connected to node N. Each edge in set of edges R is a unidirectional edge incoming to node N.

At step 806, the GOFS 109 identifies a set of nodes NT related to set of edges T, and a set of nodes NR related to set of edges R. Each node in set of nodes NT is a node that is connected to node N by an edge in set of edges T and is therefore traversable from node N. Each node in set of nodes NR is a node that is connected to node N by an edge in set of edges R and is therefore non-traversable from node N.

At step 809, the GOFS 109 selects a node S from the set of nodes NT (unless set of nodes NT is an empty set). Node S may be selected at random from set of nodes NT. The GOFS 109 then connects, to node S, every other node from set of nodes NT to node S, if any other nodes exist in set of nodes NT. Those nodes are connected to node S with bidirectional edges.

At step 812, the GOFS 109 selects a node U from set of nodes NR (unless set of nodes NT is an empty set). Node U may be selected at random from set of nodes NR. In some examples, node U may be selected from nodes in set of nodes NR that can access the spotlight node of the graph and/or node N. In examples where node S can access the spotlight node, though, node U may be selected from any of the nodes in set of nodes NR. The GOFS 109 then connects node U to node S. Node U and node S are connected using a bidirectional edge.

At step 815, the GOFS 109 removes node N, set of edges T, and set of edges R from the graph. Node N, set of edges T, and set of edges R can be removed from the graph without leaving any orphan nodes. No orphan nodes are created by the deletion because of the new edges connecting node S to node U and the other nodes from set of nodes NT. The file represented by node N may likewise be removed from the GOFS 109.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

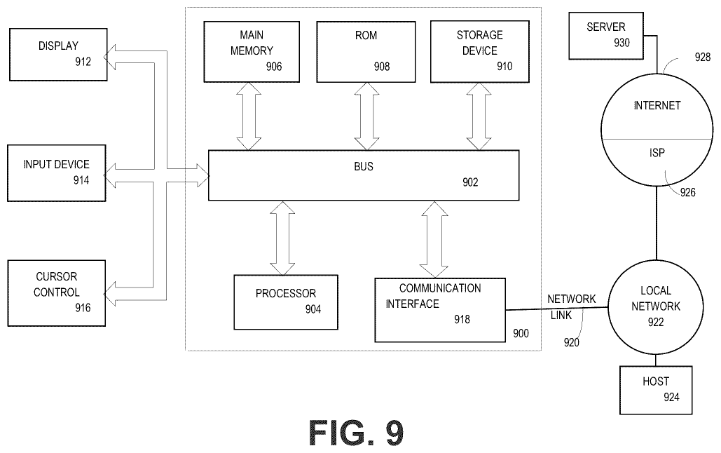

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### 8. SOFTWARE OVERVIEW

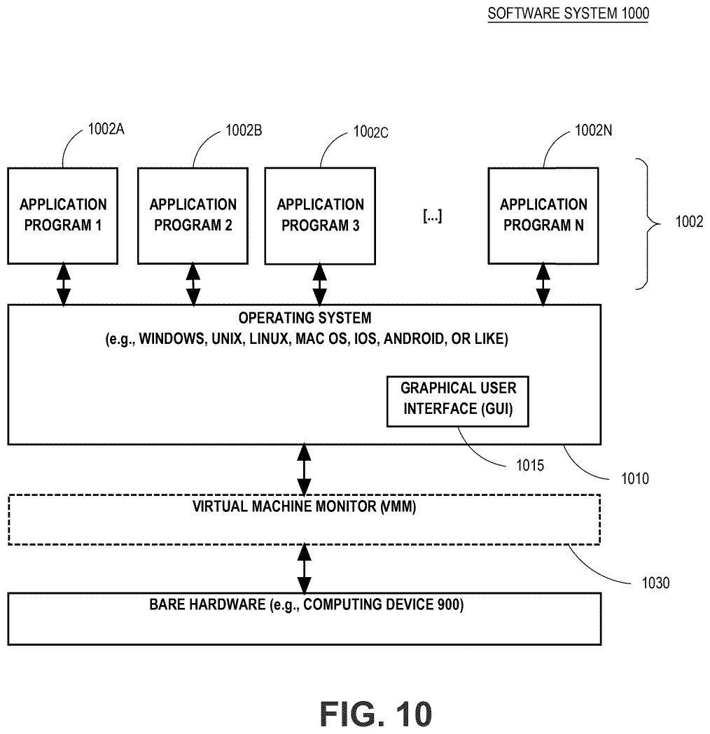

FIG. 10 is a block diagram of a basic software system 1000 that may be employed for controlling the operation of computing system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computing system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 1000 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The terms “cloud” and “cloud computing” are generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
maintaining a graph-organized file system (GOFS) that represents a graph comprising a plurality of nodes and one or more edges representing one or more relationships between the plurality of nodes;
causing rendering, in a display accessible to one or more computing devices, a user interface comprising a representation of at least a portion of the graph;
receiving, via the user interface, a file system command for the GOFS; and
modifying the user interface based at least in part on executing the file system command.

2. The method of claim 1, wherein the at least a portion of the graph is a first portion of the graph comprising a first subset of the plurality of nodes, the method further comprising:
modifying the user interface to comprise a representation of a plurality of workspaces;
receiving a selection of a selectable component corresponding to one of the plurality of workspaces in the user interface; and
in response to the selection, modifying the user interface to comprise a representation of a second portion of the graph comprising a second subset of the plurality of nodes.

3. The method of claim 2, wherein a node of the second subset of the plurality of nodes is designated as a spotlight node associated with the one of the plurality of workspaces, and individual nodes of the second subset of the plurality of nodes are within a predetermined number of hops from the spotlight node.

4. The method of claim 3, wherein the predetermined number of hops is a first predetermined number of hops, the method further comprising:
receiving selection of a second predetermined number of hops that is different from the first predetermined number of hops; and
modifying the user interface to comprise a representation of a third portion of the graph comprising third subset of nodes, wherein individual nodes of the third subset of nodes are within the second predetermined number of hops from the spotlight node.

5. The method of claim 1, further comprising:
receiving a command to create a new node within the plurality of nodes;
generating a modified graph that comprises the plurality of nodes and the new node; and
modifying the user interface to comprise a representation of a portion of the modified graph comprising at least a subset of the plurality of nodes and the new node.

6. The method of claim 1, further comprising:
receiving a command to delete a particular node of the plurality of nodes;
generating a modified graph that excludes the particular node and one or more particular edges related to the particular node and comprises one or more new edges related to one or more neighboring nodes of particular node in the plurality of nodes; and
modifying the user interface to comprise the modified graph.

7. The method of claim 1, further comprising:
receiving a command to delete a particular node of the plurality of nodes;
identifying one or more traversable edges related to the particular node, wherein the one or more traversable edges are traversable from the particular node;
identifying a plurality of first nodes that are related to the one or more traversable edges;
identifying one or more non-traversable edges related to the particular node, wherein the one or more non-traversable edges are not traversable from the particular node;
identifying a plurality of second nodes that are related to the one or more non-traversable edges;
generating a modified graph based at least in part on a modification of the graph, wherein the modification of the graph comprises:
including in the graph one or more first bidirectional edges representing one or more relationships between a selected node of the plurality of first nodes and one or more other nodes of the plurality of first nodes,
including in the graph a second bidirectional edge representing a relationship between the selected node of the plurality of first nodes and a selected node of the plurality of second nodes, and
excluding from the graph the particular node, the one or more traversable edges, and the one or more non-traversable edges; and
modifying the user interface to comprise the modified graph.

8. The method of claim 1, further comprising:
receiving a command to delete a particular edge of the one or more edges;
generating, based at least on input received via the user interface, a modified graph that excludes the particular edge; and
modifying the user interface to comprise the modified graph.

9. The method of claim 1, further comprising:
receiving, via the user interface, search criteria comprising a node property or an edge property; and
identifying one or more nodes having the node property or one or more edges having the edge property; and
modifying the user interface to comprise an indication of the one or more nodes or the one or more edges.

10. The method of claim 9, wherein modifying the user interface to comprise the indication of the one or more nodes or the one or more edges further comprises displaying, in the user interface a representation of the one or more nodes or a representation of the one or more edges.

11. One or more non-transitory storage media storing instructions which, when executed by one or more computing devices, cause:
maintaining a graph-organized file system (GOFS) that represents a graph comprising a plurality of nodes and one or more edges representing one or more relationships between the plurality of nodes;
causing rendering, in a display accessible to the one or more computing devices, a user interface comprising a representation of at least a portion of the graph;
receiving, via the user interface, a file system command for the GOFS; and
modifying the user interface based at least in part on executing the file system command.

12. The one or more non-transitory storage media of claim 11, wherein the at least a portion of the graph is a first portion of the graph comprising a first subset of the plurality of nodes, and the instructions, when executed by the one or more computing devices, further cause:
modifying the user interface to comprise a representation of a plurality of workspaces;
receiving a selection of a selectable component corresponding to one of the plurality of workspaces in the user interface; and
in response to the selection, modifying the user interface to comprise a representation of a second portion of the graph comprising a second subset of the plurality of nodes.

13. The one or more non-transitory storage media of claim 12, wherein a node of the second subset of the plurality of nodes is designated as a spotlight node associated with the one of the plurality of workspaces, and individual nodes of the second subset of the plurality of nodes are within a predetermined number of hops from the spotlight node.

14. The one or more non-transitory storage media of claim 13, wherein the predetermined number of hops is a first predetermined number of hops, and the instructions, when executed by the one or more computing devices, further cause:
receiving selection of a second predetermined number of hops that is different from the first predetermined number of hops; and
modifying the user interface to comprise a representation of a third portion of the graph comprising third subset of nodes, wherein individual nodes of the third subset of nodes are within the second predetermined number of hops from the spotlight node.

15. The one or more non-transitory storage media of claim 11, wherein the instructions, when executed by the one or more computing devices, further cause:
receiving a command to create a new node within the plurality of nodes;
generating a modified graph that comprises the plurality of nodes and the new node; and
modifying the user interface to comprise a representation of a portion of the modified graph comprising at least a subset of the plurality of nodes and the new node.

16. The one or more non-transitory storage media of claim 11, wherein the instructions, when executed by the one or more computing devices, further cause:
receiving a command to delete a particular node of the plurality of nodes;
generating a modified graph that excludes the particular node and one or more particular edges related to the particular node and comprises one or more new edges related to one or more neighboring nodes of particular node in the plurality of nodes; and
modifying the user interface to comprise the modified graph.

17. The one or more non-transitory storage media of claim 11, wherein the instructions, when executed by the one or more computing devices, further cause:
receiving a command to delete a particular node of the plurality of nodes;
identifying one or more traversable edges related to the particular node, wherein the one or more traversable edges are traversable from the particular node;
identifying a plurality of first nodes that are related to the one or more traversable edges;
identifying one or more non-traversable edges related to the particular node, wherein the one or more non-traversable edges are not traversable from the particular node;
identifying a plurality of second nodes that are related to the one or more non-traversable edges;
generating a modified graph based at least in part on a modification of the graph, wherein the modification of the graph comprises:
including in the graph one or more first bidirectional edges representing one or more relationships between a selected node of the plurality of first nodes and one or more other nodes of the plurality of first nodes,
including in the graph a second bidirectional edge representing a relationship between the selected node of the plurality of first nodes and a selected node of the plurality of second nodes, and
excluding from the graph the particular node, the one or more traversable edges, and the one or more non-traversable edges; and
modifying the user interface to comprise the modified graph.

18. The one or more non-transitory storage media of claim 11, wherein the instructions, when executed by the one or more computing devices, further cause:
receiving a command to delete a particular edge of the one or more edges;
generating, based at least on input received via the user interface, a modified graph that excludes the particular edge; and
modifying the user interface to comprise the modified graph.

19. The one or more non-transitory storage media of claim 11, wherein the instructions, when executed by the one or more computing devices, further cause:
receiving, via the user interface, search criteria comprising a node property or an edge property; and
identifying one or more nodes having the node property or one or more edges having the edge property; and
modifying the user interface to comprise an indication of the one or more nodes or the one or more edges.

20. The one or more non-transitory storage media of claim 19, wherein modifying the user interface to comprise the indication of the one or more nodes or the one or more edges further comprises displaying, in the user interface a representation of the one or more nodes or a representation of the one or more edges.
